(19) United States
(12) Patent Application Publication
(10) Pub. No.: US 2024/0333847 A1
(43) Pub. Date: Oct. 3, 2024

(54) INFORMATION PROCESSING APPARATUS THAT ENABLES EASY USE OF RANGING FUNCTION BY UWB COMMUNICATION, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: MOTOKI KOSHIGAYA, Saitama (JP)

(21) Appl. No.: 18/612,195

(22) Filed: Mar. 21, 2024

(30) Foreign Application Priority Data
Mar. 27, 2023 (JP) 2023-049818

(51) Int. Cl. H04N 1/00; G01S 13/02; G01S 13/08

(52) U.S. Cl. CPC H04N 1/00427; G01S 13/0209; G01S 13/08

(57) ABSTRACT

An information processing apparatus that executes predetermined processing in cooperation with a cooperation target apparatus. A mobile terminal receives an advertising packet transmitted by BLE communication and displays a device list screen for prompting a user to select the cooperation target apparatus on a display thereof based on the advertising packet. In a case where a transmission source of the advertising packet is an apparatus supporting UWB communication which makes it possible to acquire distance information with higher accuracy than BLE communication, the device list screen including an object for instructing ranging between the mobile terminal and the transmission source by UWB communication is displayed on the display of the mobile terminal.

### BACKGROUND OF THE INVENTION

### Field of the Invention

The present invention relates to an information processing apparatus that enables easy use of a ranging function by Ultra-Wide Band (UWB) communication, a method of controlling the information processing apparatus, and a storage medium.

### Description of the Related Art

In recent years, an image forming apparatus, such as a printer, a copy machine, or a multifunction peripheral, is required to expand a function of cooperating with an information processing apparatus, such as a smartphone or a tablet terminal, in accordance with increased business use of the information processing apparatus. For example, there has been provided an image forming apparatus cooperative application that can realize cooperation with the image forming apparatus in a scan function, a print function, a job transmission function, and so forth. An information processing apparatus in which the image forming apparatus cooperative application is installed performs processing for searching for an image forming apparatuses located near the information processing apparatus. The information processing apparatus displays a plurality of image forming apparatuses found by the search on a display section thereof as cooperative apparatus candidates and transmits job data including document data and print settings information (such as a color print setting and a double-sided print setting) to an image forming apparatus selected by a user from the cooperative apparatus candidates.

In the search processing, for example, a distance between the information processing apparatus and each apparatus located in the vicinity of the information processing apparatus is measured by wireless communication based on a BLE standard, and based on distance information obtained by the distance measurement (ranging), cooperative apparatus candidates are displayed on the display section (see, for example, Japanese Laid-Open Patent Publication (Kokai) No. 2021-72573). Note the BLE is an abbreviation of Bluetooth Low Energy. Further, there been proposed a technique for using wireless communication based on a UWB standard which makes it possible to acquire distance information with higher accuracy than BLE communication when measuring a distance between apparatuses (see, for example, Japanese Laid-Open Patent Publication (Kokai) No. 2021-96143).

As described above, under circumstances where measurement of a distance between apparatuses can be realized by wireless communication based on a variety of wireless communication standards, there is a demand for a mechanism that enables easy use of a ranging function by UWB communication capable of acquiring highly accurate distance information with respect to a ranging target apparatus equipped with a UWB communication function.

### SUMMARY OF THE INVENTION

The present invention provides a mechanism that enables easy use of a ranging function by UWB communication capable of acquiring highly accurate distance information with respect to a ranging target apparatus equipped with the UWB communication function.

In a first aspect of the present invention, there is provided an information processing apparatus that executes predetermined processing in cooperation with a cooperation target apparatus, including a receiving unit configured to receive an advertising packet transmitted by first wireless communication, and a control unit configured to display a list screen for prompting a user to select the cooperation target apparatus on a display unit of the information processing apparatus based on the advertising packet, wherein in a case where a transmission source of the advertising packet is an apparatus supporting second wireless communication which makes it possible to acquire distance information with higher accuracy than the first wireless communication, the control unit displays, on the display unit of the information processing apparatus, the list screen including an object for instructing ranging between the information processing apparatus and the transmission source by the second wireless communication.

In a second aspect of the present invention, there is provided a method of controlling an information processing apparatus that executes predetermined processing in cooperation with a cooperation target apparatus, including receiving an advertising packet transmitted by first wireless communication, and performing control to display a list screen for prompting a user to select the cooperation target apparatus on a display unit of the information processing apparatus based on the advertising packet, wherein in a case where a transmission source of the advertising packet is an apparatus supporting second wireless communication which makes it possible to acquire distance information with higher accuracy than the first wireless communication, the control includes displaying, on the display unit of the information processing apparatus, the list screen including an object for instructing ranging between the information processing apparatus and the transmission source by the second wireless communication.

According to the present invention, it is possible to easily use the ranging function by UWB communication capable of acquiring highly accurate distance information with respect to a ranging target apparatus equipped with the UWB communication function.

Further features of the present invention will become apparent from the following description of exemplary embodiments (with reference to the attached drawings).

### BRIEF DESCRIPTION OF THE DRAWINGS

FIG. 1 is a diagram showing a configuration of a data processing system including a mobile terminal as an information processing apparatus according to an embodiment of the present invention.

FIG. 2 is a block diagram showing a hardware configuration of the mobile terminal appearing in FIG. 1.

FIG. 3 is a block diagram showing a hardware configuration of an image forming apparatus appearing in FIG. 1.

FIG. 4 is a block diagram useful in explaining a software configuration of the mobile terminal appearing in FIG. 1 and a data area managed by the software.

FIG. 5 is a block diagram useful in explaining a software

configuration of the image forming apparatus appearing in FIG. 1 and a data area managed by the software.

FIG. 6 is a diagram showing a ranging method by UWB communication, applied in the data processing system shown in FIG. 1.

FIG. 7 is a sequence diagram showing a procedure of a cooperative apparatus candidate-displaying process performed in the data processing system according to the present embodiment.

FIG. 8 is a flowchart of a BLE communication control process performed by the image forming apparatus appearing in FIG. 1.

FIG. 9A is a diagram showing a structure of a BLE advertising packet transmitted from each image forming apparatus appearing in FIG. 1, which is equipped with a UWB communication function.

FIG. 9B is a diagram showing packet specification used in the UWB ranging in the data processing system shown in FIG. 1.

FIG. 9C is a diagram showing a specification of a communication capability message in Common Service Management Layer (CSML) which is a communication protocol defined by FiRa and can be applied to the data processing system shown in FIG. 1.

FIG. 9D is a diagram showing a specification of a communication configuration message in the communication protocol (CSML).

FIG. 10 is a flowchart of a list display control process performed by the mobile terminal appearing in FIG. 1.

FIGS. 11A to 11F are diagrams each showing an example of a screen displayed on a display appearing in FIG. 2.

FIG. 12 is a flowchart of a variation of the list display control process performed by the mobile terminal appearing in FIG. 1.

FIG. 13 is a flowchart of a UWB ranging process for all UWB-supporting devices, which is performed in a step in FIG. 12.

FIGS. 14A to 14C are diagrams each showing an example of a screen displayed on the display appearing in FIG. 2.

### DESCRIPTION OF THE EMBODIMENTS

The present invention will now be described in detail below with reference to the accompanying drawings showing embodiments thereof.

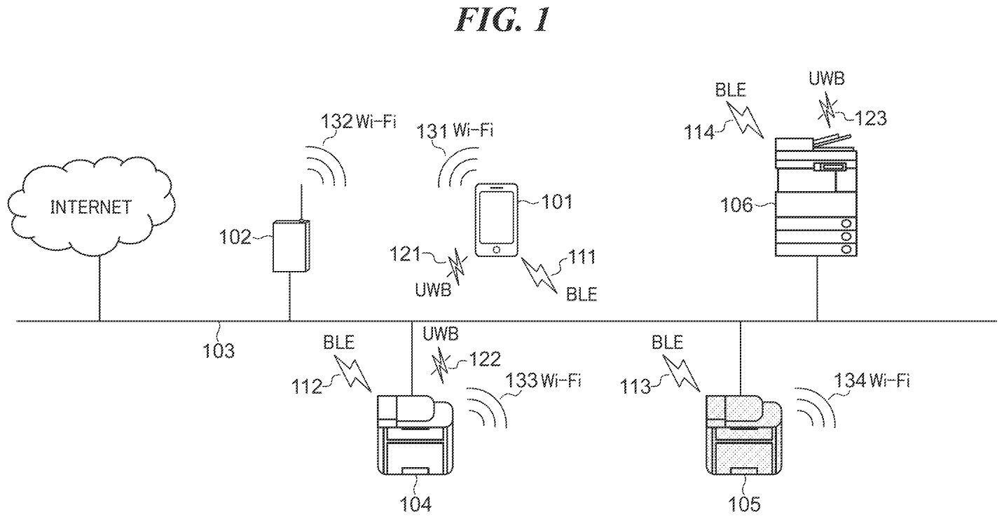

FIG. 1 is a diagram showing a configuration of a data processing system 1 including a mobile terminal 101 as an information processing apparatus according to an embodiment of the present invention.

Referring to FIG. 1, the data processing system 1 includes the mobile terminal 101, a wireless Local Area Network (LAN) terminal 102, a LAN 103, and image forming apparatuses 104 to 106.

The mobile terminal 101 as the information processing apparatus transmits a print job to one of the image forming apparatuses 104 to 106. The mobile terminal 101 is equipped with a plurality of wireless communication functions which are different in communication standard. For example, the mobile terminal 101 is equipped with a BLE communication function for performing Bluetooth Low Energy (BLE) communication (first wireless communication) and a UWB communication function for performing communication based on a Ultra Wideband (UWB) standard (hereinafter referred to as “UWB communication”) (second wireless communication). In UWB communication, it is possible to more accurately measure a distance to a target apparatus than BLE communication. Further, the mobile terminal 101 is equipped with a Wi-Fi communication function for performing wireless communication based on a Wi-Fi standard (hereinafter referred to as “Wi-Fi communication”).

The image forming apparatuses 104 to 106 each are equipped with a printer function and a wireless communication function. Note that the image forming apparatuses 104 to 106 can be further equipped with, for example, a copy function, a scanner function, and a fax transmission function. The image forming apparatus 104 is equipped with the BLE communication function, the UWB communication function, and the Wi-Fi communication function, as wireless communication functions. The image forming apparatus 105 is equipped with the BLE communication function and the and the Wi-Fi communication function but not equipped with the UWB communication function, as wireless communication functions. The image forming apparatus 106 is equipped with the BLE communication function and the UWB communication function, but not equipped with the Wi-Fi communication function, as wireless communication functions.

The wireless LAN terminal 102 is a parent device of a wireless LAN having a general network-router function and provides the wireless LAN via Wi-Fi in a home, an office, or the like. Further, the mobile terminal 101 is connected to the LAN 103 via the wireless LAN terminal 102 by enabling the Wi-Fi function. When the mobile terminal 101 enters a wireless LAN area provided by the wireless LAN terminal 102, the mobile terminal 101 can automatically participate in the network of the LAN 103 by using authentication information set in advance.

The LAN 103 connects between, for example, the mobile terminal 101 and the image forming apparatuses 104 to 106, and the apparatuses connected in the data processing system 1 exchange information by intercommunication via the LAN 103. Further, the LAN 103 is also connected to the Internet.

Signals 111 to 114 are BLE radio signals transmitted and received by the mobile terminal 101 and the image forming apparatuses 104 to 106. A wireless personal area network (WPAN) can be formed between the apparatuses within reach of the signals 111 to 114.

Signals 121 to 123 are UWB radio signals transmitted and received by the mobile terminal 101 and the image forming apparatuses 104 and 106. A WPAN can be formed between the apparatuses located within reach of the signals 121 to 123.

Signals 131 to 134 are Wi-Fi radio signals transmitted and received by the mobile terminal 101, the wireless LAN terminal 102, and the image forming apparatuses 104 and 105. A WPAN can be formed between the apparatuses located within reach of the signals 131 to 124.

The image forming apparatuses 104 to 106 each transmit a BLE advertising packet at fixed time intervals and can be shifted to a connection state when a pairing request is received from the mobile terminal 101.

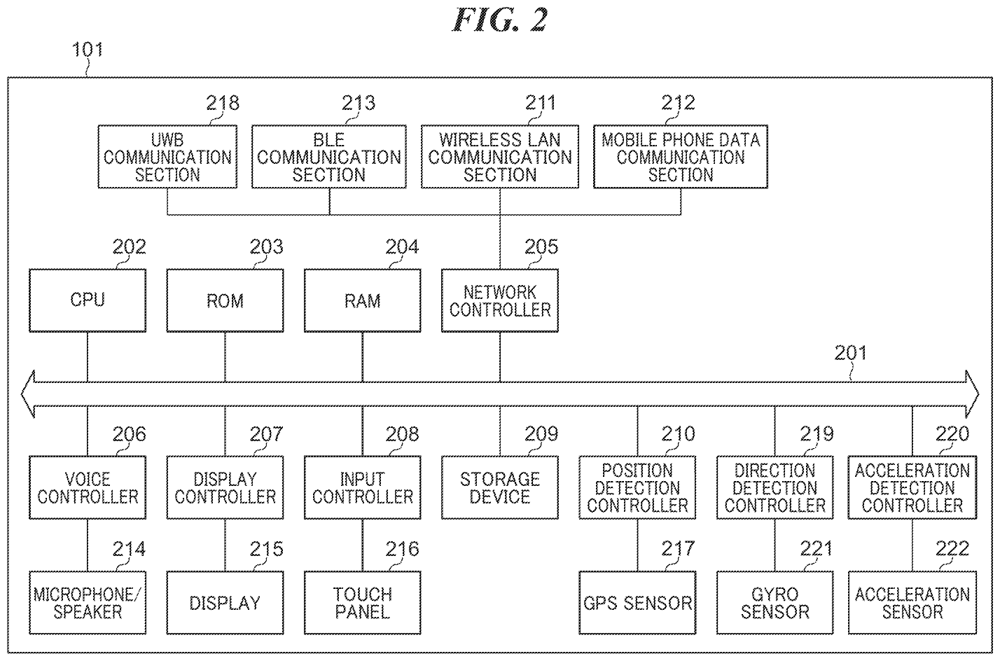

FIG. 2 is a block diagram showing a hardware configuration of the mobile terminal 101 appearing in FIG. 1.

The mobile terminal 101 is a terminal which can be carried by a user, such as a smartphone and a tablet, and on which an operating system (OS) for the terminal and programs for controlling speech communication and data communication can operate. Note that the mobile terminal 101 can be an apparatus which is not equipped with a microphone/speaker 214, a GPS sensor 217, a gyro sensor 221, an acceleration sensor 222, controllers (206, 210, 219, and 220) for controlling these components, a mobile phone data communication section 212, and so forth, described hereinafter. Examples of such a apparatus include a portable personal computer, such as a laptop-type personal computer. The hardware components are directly or indirectly connected to a system bus 201.

Referring to FIG. 2, the mobile terminal 101 includes a central processing unit (CPU) 202, a read only memory (ROM) 203, a random access memory (RAM) 204, a network controller 205, the voice controller 206, a display controller 207, an input controller 208, a storage device 209, the position detection controller 210, and a wireless LAN communication section 211. Further, the mobile terminal 101 includes the mobile phone data communication section 212, a BLE communication section 213, the microphone/speaker 214, a display 215, a touch panel 216, the GPS sensor 217, a UWB communication section 218, and the direction detection controller 219. Further, the mobile terminal 101 includes the acceleration detection controller 220, the gyro sensor 221, and the acceleration sensor 222.

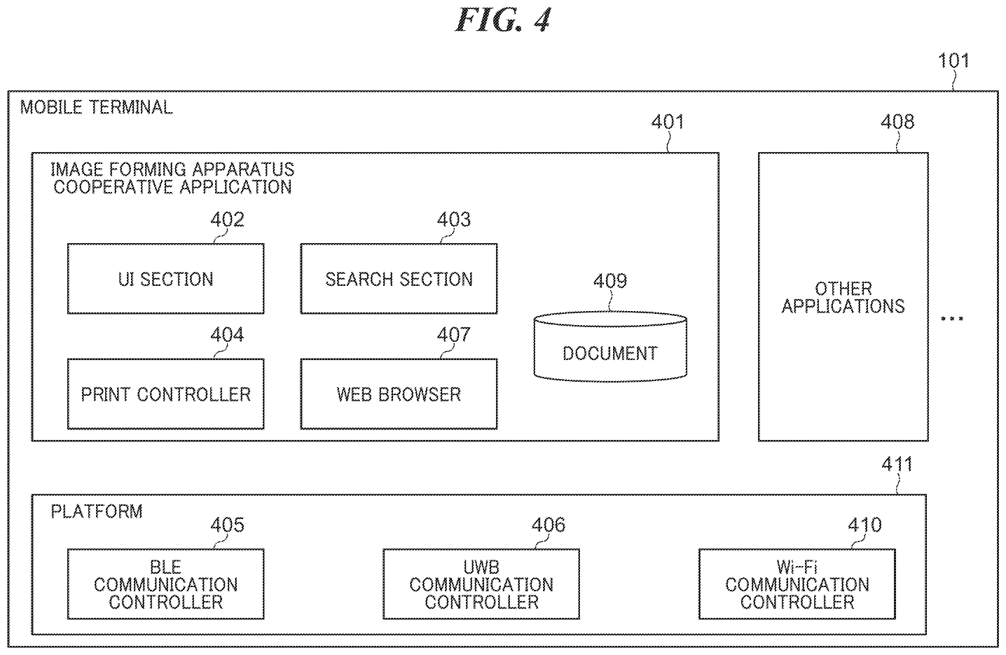

The ROM 203 stores the OS and applications for controlling speech communication and data communication, installed in the mobile terminal 101, which are executed by the CPU 202. The applications for controlling data communication include not only an image forming apparatus cooperative application 401, described hereinafter with reference to FIG. 4, but also mail software and a Web browser, not shown, and so forth.

The RAM 204 is a memory for executing programs and is a work memory area used by applications to execute programs therefor. Further, the RAM 204 is also used to temporarily store data required to be temporarily stored when an application executes a program, and the like.

The storage device 209 is a nonvolatile storage device storing a variety of operation mode settings required to be held even after the mobile terminal 101 is restarted, an operation log, and so forth.

The network controller 205 controls communication performed by the wireless LAN communication section 211, the mobile phone data communication section 212, the BLE communication section 213, and the UWB communication section 218. The wireless LAN communication section 211 is a communication section that participates in the network of the LAN 103 via the wireless LAN terminal 102, and the mobile phone data communication section 212 is a communication section for participating in a network provided by a mobile phone carrier. The BLE communication section 213 is a communication section for forming a WPAN between peripheral computer devices located within reach of BLE radio signals for mutual communication. The UWB communication section 218 is a communication section for forming a WPAN in which ranging and data communication are performed between peripheral computer devices located within reach of UWB radio signals for mutual communication.

Here, when the mobile terminal 101 can participate in the network of the wireless LAN, the network controller 205 gives the priority to connection of the wireless LAN. In a case where the mobile terminal 101 has moved out of the network area of the wireless LAN, exclusive control is performed so as to cause the mobile terminal 101 to participate in a wireless communication network provided by the mobile phone carrier, but in the BLE communication and the UWB communication, the communication function is independently controlled to achieve the purpose of the communication.

The voice controller 206 is used, for example, when a speech application is started, and the user is calling on the phone. Specifically, when voice data is input and output to and from the microphone/speaker 214, the voice controller 206 mediates the voice data and a voice data control program. The display controller 207 controls information output on the display 215 of the mobile terminal 101. The input controller 208 controls information designated by a user using a button (not shown) arranged on the mobile terminal 101 or the touch panel 216. The applications operating on the mobile terminal 101 provide network communication information and a variety of information of the mobile terminal 101 to a user by using the voice controller 206, the display controller 207, and the input controller 208.

The position detection controller 210 acquires positional information of the mobile terminal 101 from the GPS sensor 217 and provides the acquired information to the OS. The direction detection controller 219 acquires direction information of the mobile terminal 101 from the gyro sensor 221 and provides the acquired information to the OS. The acceleration detection controller 220 acquires acceleration information of the mobile terminal 101 from the acceleration sensor 222 and provides the acquired information to the OS. These controls are controlled by the OS operating on the CPU 202.

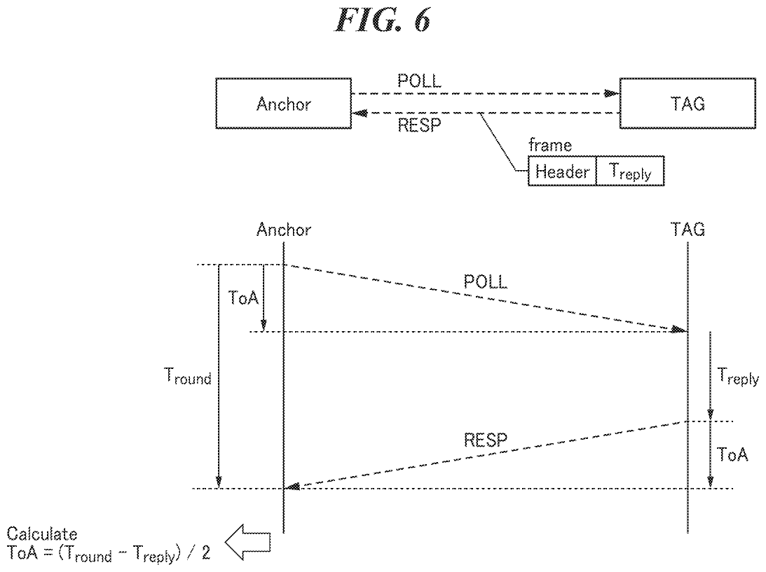

The mobile terminal 101 is capable of performing ranging communication for measuring a distance from each of the image forming apparatuses 104 and 106 via the UWB communication section 218. The UWB communication section 218 at least supports Two Way Ranging (TWR) shown in FIG. 6 as a ranging communication method. The mobile terminal 101 transmits ranging request data and receives corresponding ranging response data via this UWB communication section 218. The mobile terminal 101 is capable of providing distance information generated by the CPU 202 performing distance calculation by data processing, at a request timing expected by the application. Thus, the mobile terminal 101 can provide information on a distance not only from each of the image forming apparatuses 104 and 106 in the system configuration shown in FIG. 1, but also from each of peripheral devices, not shown, supporting UWB communication.

Further, in a case where a request for distance measurement is sent from any of the image forming apparatuses 104 and 106, or from any of the other peripheral devices, the mobile terminal 101 can also cope with the request. In this case, the mobile terminal 101 can transmit ranging response data in response to reception of the ranging request data by the ranging communication method of TWR.

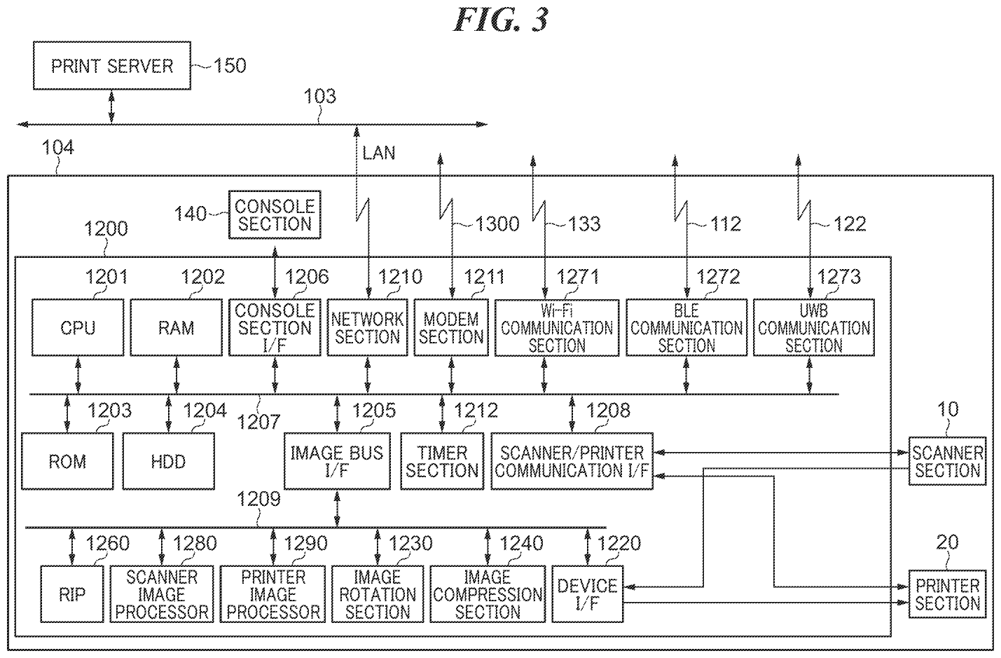

FIG. 3 is a block diagram showing a hardware configuration of the image forming apparatus 104 appearing in FIG. 1. Note that the image forming apparatus 105 is not equipped with a UWB communication section 1273, described hereinafter, and the image forming apparatus 106 is not equipped with a Wi-Fi communication section 1271, described hereinafter, but the image forming apparatuses 105 and 106 are the same in configuration in respect of the other components as the image forming apparatus 104, and hence description thereof is omitted.

The image forming apparatus 104 includes a console section 140 used by a user to perform a variety of operations, a scanner section 10 that reads image information according to an instruction from the console section 140, a printer section 20 that prints image data on a sheet, and a controller 1200.

The scanner section 10 has a CPU that controls the scanner section 10, and an illumination lamp, a scanning mirror, and so forth, not shown, for reading an original. The printer section 20 has a CPU that controls the printer section 20, and photosensitive drums and a fixer, not shown, for forming an image and fixing the image.

The controller 1200 controls the scanner section 10, the printer section 20, and the console section 140, and performs centralized control of communication with external information devices, including the mobile terminal 101 and a print server 150, connected, for example, via the LAN 103 and the wireless LAN.

The controller 1200 includes the Wi-Fi communication section 1271, a BLE communication section 1272, and the UWB communication section 1273, which can perform wireless communication with the external mobile terminal 101. These are connected to a system bus 1207, described hereinafter.

Further, the controller 1200 has a raster image processor (RIP) 1260 that rasterizes a page description language (PDL) code included in a print job received from the mobile terminal 101 into a bitmap image.

Further, the controller 1200 has a scanner image processor 1280 that performs correction, processing, and editing on image data input from the scanner section 10.

Further, the controller 1200 has a printer image processor 1290 that performs correction, resolution conversion, and the like, on image data to be output (printed) by the printer section 20, and an image rotation section 1230 that rotates image data.

Further, the controller 1200 has an image compression section 1240 that performs compression/expansion processing on multi-value image data according to the Joint Photographic Experts Group (JPEG) and performs compression/expansion processing on binary image data according to the Joint Bi-level image experts Group (JBIG), Modified Modified Read (MMR), or Modified Huffman (MH).

Further, the controller 1200 has a device interface 1220 that connects between the scanner section 10 and the printer section 20 and performs synchronous/asynchronous conversion of image data.

Further, the controller 1200 has an image bus 1209 that interconnects between the RIP 1260, the scanner image processor 1280, the printer image processor 1290, the image rotation section 1230, the image compression section 1240, and the device interface 1220, and transfers image data at high speed.

Further, the controller 1200 has a CPU 1201 as a controller that performs centralized control of the image forming apparatus 104.

Further, the controller 1200 has a RAM 1202 that functions as a system work memory for the operation of the CPU 1201 and also functions as an image memory for temporarily storing image data.

Further, the controller 1200 has a console section interface 1206. Image data to be displayed on the console section 140 is output to the console section 140 via the console section interface 1206. Further, the console section interface 1206 plays a role of transferring information input by a user of the image forming apparatus 104 from the console section 140 to the CPU 1201.

Further, the controller 1200 has a network section 1210 that is connected to the LAN 103 and performs data communication with (data transmission and reception to and from) the print server 150 and other computer terminals, not shown, on the LAN 103.

Further, the controller 1200 has a modem section 1211 that is connected to a public line 1300 and performs data communication with (data transmission and reception to and from) an external facsimile device, not shown.

Further, the controller 1200 includes a ROM 1203 that stores a boot program executed by the CPU 1201 and a hard disk drive (HDD) 1204 that stores system software, image data, software counter values, and so forth.

Further, the controller 1200 has a scanner/printer communication interface 1208 that performs communication with the scanner section 10 and the printer section 20, and a timer section 1212 used for measuring time when ranging using UWB (hereafter referred to as “UWB ranging”), described hereinafter, is performed.

Further, the controller 1200 includes the system bus 1207. The system bus 1207 interconnects between the CPU 1201, the RAM 1202, the console section interface 1206, the timer section 1212, the network section 1210, the modem section 1211, the ROM 1203, the HDD 1204, and the scanner/printer communication interface 1208.

The controller 1200 includes an image bus interface 1205 that functions as a bus bridge for connecting between the system bus 1207 and the image bus 1209 and converting the data structure.

The controller 1200 records and manages job execution history, including a user name, the number of copies, color print information, output attribute information, and so forth, at the time of execution of a print or a copy job, in the HDD 1204 or the RAM 1202, as job log information.

FIG. 4 is a block diagram useful in explaining a software configuration of the mobile terminal 101 and a data area managed by the software. The software shown in FIG. 4 is realized by the CPU 202 that executes programs loaded in the RAM 204.

As shown in FIG. 4, the mobile terminal 101 includes the image forming apparatus cooperative application 401, other applications 408, and a platform 411.

The image forming apparatus cooperative application 401 is one of applications executed by the CPU 202 on the mobile terminal 101 for processing according to the present embodiment, and is installed in the ROM 203 as an application operating on the OS.

The platform 411 can be implemented by a platform, such as Google's Android (registered trademark) or Apple's iOS (registered trademark). The platform 411 includes a device driver group for controlling a variety of hardware items and provides an application programming interface (API) for using the variety of hardware items for the applications operating on the platform 411. Here, an API conforming to the CSML specification standardized by the FiRa consortium, which is an organization promoting the use of UWB, is provided for BLE communication and UWB communication. Here, the CSML is an abbreviation of Common Service Management Layer. Note that an API conforming to Apple's “Nearby Interaction” can be provided for BLE communication and UWB communication. As the device driver group, a BLE communication controller 405, a UWB communication controller 406, and a Wi-Fi communication controller 410 exist.

As shown in FIG. 4, the image forming apparatus cooperative application 401 has a user interface (UI) section 402, a search section 403, a print controller 404, a Web browser 407, and a document 409.

The document 409 indicates an area of data stored in the RAM 204 and managed by the software. The UI section 402 provides a user interface for prompting a user to set a function unique to the image forming apparatus cooperative application 401.

The search section 403 searches the LAN 103 in which the mobile terminal 101 participates, for a network device supporting the multicast Domain Name System (mDNS). Then, the search section 403 provides a function of acquiring detailed information from any of network devices which can be reached on the LAN 103, to which the mobile terminal 101 can provide a print instruction (i.e. which is supported by the image forming apparatus cooperative application 401), by using IPP or IPP over SSL/TLS (IPPS). Here, IPP is an abbreviation of Internet Printing Protocol. Note that the communication system is not limited to mDNS and IPP. Further, the search section 403 provides a function of searching for an image forming apparatus to which the mobile terminal 101 can provide a print instruction in the WPAN in which BLE transmission/reception can be performed by the BLE communication controller 405. Further, the search section 403 provides a function of acquiring distance information by controlling communication for measuring a distance between the image forming apparatus found by the search and the mobile terminal 101, using the UWB communication controller 406. Hereafter, although a description will be given of a case where the image forming apparatus found by the search is the image forming apparatus 104, the description is the same in a case where the image forming apparatus 106 is found by the search.

The print controller 404 provides a function of generating a print job to be provided to the image forming apparatus 104 and transmitting the generated print as job data. The image forming apparatus cooperative application 401 can be equipped with not only a print instruction function, but also, for example, a function of providing a scan instruction to the image forming apparatus 104.

As described above, the mobile terminal 101 can realize the function of searching for apparatuses, such as the image forming apparatuses 104 to 106, which are connected to the same network to which the mobile terminal 101 is connected and are capable of performing BLE communication, and displaying a list of apparatuses found by the search on the display 215.

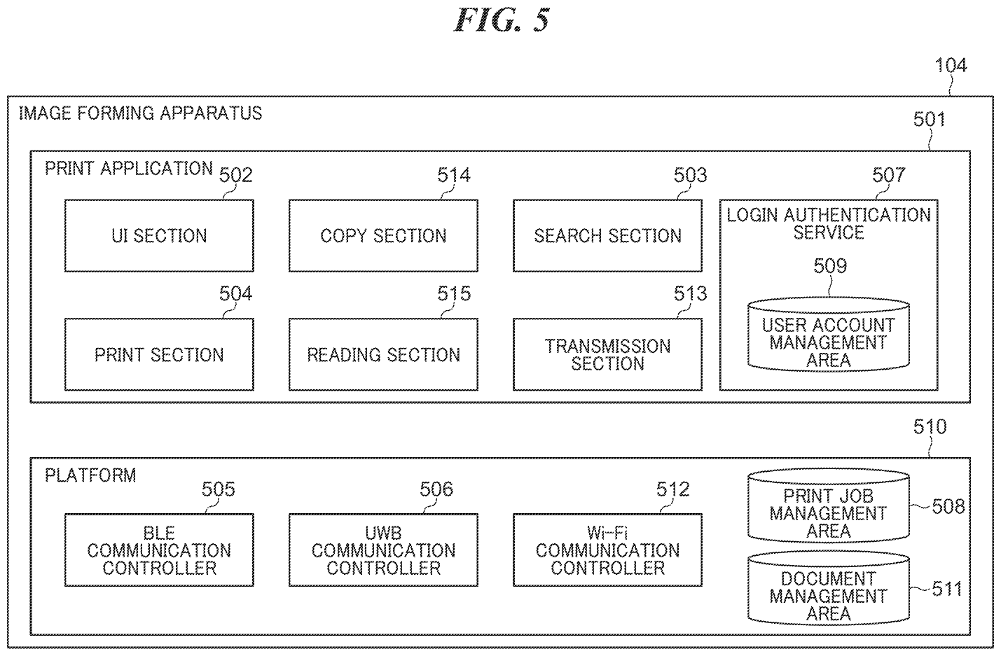

FIG. 5 is a block diagram useful in explaining a software configuration of the image forming apparatus 104 and a data area managed by the software. Note that the image forming apparatus 105 is not equipped with a UWB communication controller 506, described hereinafter, and the image forming apparatus 106 is not equipped with a Wi-Fi communication controller 512, described hereinafter, but the image forming apparatuses 105 and 106 have the same configuration as the image forming apparatus 104 except for these components, and hence description thereof is omitted. Further, the software shown in FIG. 5 is realized by the CPU 1201 executing programs loaded in the RAM 1202.

As shown in FIG. 5, the image forming apparatus 104 has a print application 501, a login authentication service 507, and a platform 510.

The print application 501 is one of applications executed by the CPU 1201 on the image forming apparatus 104 and has been installed in the ROM 1203 as an application operating on the OS.

Referring to FIG. 5, a print job management area 508 and a document management area 511 in the platform 510 indicate areas of data stored in the RAM 1202 or the HDD 1204 and managed by the software. Similarly, a user account management area 509 in the login authentication service 507 also indicates an area of data stored in the RAM 1202 or the HDD 1204 and managed by the software.

The platform 510 can be formed such that it includes an OS, such as Linux (registered trademark), a JAVA (registered trademark) virtual machine, an OSGi (registered trademark) framework, and a device driver group. The JAVA is a registered trademark of Oracle Corp. The OSGi framework is a JAVA-based service platform defined by OSGi Alliance (standardization organization).

The platform 510 includes the device driver group for controlling a variety of hardware items and provides an API for using the hardware for the applications operating on the platform 510. As the device driver group, a BLE communication controller 505, the UWB communication controller 506, and the Wi-Fi communication controller 512 exist. For example, the BLE communication controller 505 is a device driver for controlling the BLE communication section 1272. The Wi-Fi communication controller 512 is a device driver for controlling the Wi-Fi communication section 1271. The USB communication controller 506 is a device driver for controlling the UWB communication section 1273. As for the protocol control using BLE communication and UWB communication, an API conforming to the “CSML specification” which is standardized by the above-mentioned FiRa consortium is provided here. Note that an API conforming to Apple's “Nearby Interaction” can be provided for BLE communication and UWB communication. Further, although not shown, a printer module for controlling the printer section 20 and a scanner module for controlling the scanner section 10 also exist in this platform 510. Further, the platform 510 provides an API for reading and writing data from and into the print job management area 508 and the user account management area 509, for the applications.

The login authentication service 507 is an application that provides a login function used when a user uses the image forming apparatus 104.

As shown in FIG. 5, the print application 501 has a UI section 502, a copy section 514, a search section 503, a print section 504, a reading section 515, and a transmission section 513.

The copy section 514 controls the reading section 515 and the print section 504 via the platform 510 to execute copying. The print section 504 provides a function of printing document data stored in the document management area 511 and job data of a print job stored in the print job management area 508. Further, the print section 504 provides a function of executing processing for printing job data received from the mobile terminal 101. This print processing can be reservation print processing for temporarily storing received job data and then printing the job data according to an instruction received from a user. Further, this print processing can be print processing for printing job data based on distance information provided from the UWB communication controller 506. The outputs of copying and printing, performed by the copy section 514, the reading section 515, the print section 504, and so forth are executed via the API of the platform 510, and the platform 510 records the number of prints in a counter, not shown. The transmission section 513 provides a function of transmitting document data acquired from the reading section 515 to the outside. The UI section 502 provides a user interface, such as a menu screen, for selecting a function unique to an application (for example, a copy, print, or transmission application) from the console section 140.

The search section 503 searches for the mobile terminal 101 having issued a print job and a registered UWB tag, described hereinafter, on the LAN 103 in which the image forming apparatus 104 participates. For this search, the BLE communication controller 505, the UWB communication controller 506, and the Wi-Fi communication controller 512, and so forth are used. Further, the search section 503 searches for a network device supporting the mDNS on the LAN 103 in which the image forming apparatus 104 participates. For this search as well, the BLE communication controller 505, the UWB communication controller 506, the Wi-Fi communication controller 512, and so forth are used. Then, the search section 503 provides a function of transmitting, by IPP or IPPS, detailed information of the image forming apparatus to an apparatus among the network devices on the LAN 103 or within reach of Wi-Fi radio signals 133, which can instruct printing to the image forming apparatus 104 (i.e. which is supported by the print application 501). Note that the communication method is not limited to mDNS and IPP. Further, the search section 503 provides a function of searching for an apparatus which can instruct printing to the image forming apparatus 104 in the WPAN where BLE communication by the BLE communication controller 505, UWB communication by the UWB communication controller 506, or Wi-Fi communication by the Wi-Fi communication controller 512 can be performed. Further, the search section 503 provides, using the UWB communication controller 506, a function of acquiring distance information by performing communication control for specific processing performed by a communication partner so as to measure a distance between the mobile terminal 101 and the communication partner.

FIG. 6 is a diagram showing the ranging method using UWB communication, applied in the data processing system 1 shown in FIG. 1. This ranging method is a method of measuring a distance between a tag and an anchor, which is defined by the IEEE 802.15.4 group. Specifically, the distance measurement is performed by calculation using a time period (ToA: Time Of Arrival) over which a frame reaches and a speed at which radio waves are propagated in space.

FIG. 6 shows a ranging method of Two Way Ranging (TWR: bidirectional ranging method) for bidirectionally transmitting a frame between the anchor and the tag. In TWR, the anchor serves as the execution entity of ranging, and the tag is a ranging target.

In measuring a distance from the tag, the anchor issues a poll frame to the tag. When the tag having received the poll frame recognizes that the destination of the poll frame is itself, the tag transmits a response to the anchor after the lapse of a time period (T_{reply}) set in advance from the reception moment. The T_{reply} value is added to this response frame.

The anchor having received the response frame calculates the ToA taken to transfer the poll frame and the response frame, by using a time (T_{round}) from the issue of the poll frame to the reception of the response frame and the T_{reply} value included in the response frame. Finally, the anchor calculates a distance to the tag based on the ToA and the propagation speed (speed of light) of radio waves.

In the data processing system 1, the image forming apparatus 104 and the mobile terminal 101 each have the UWB communication controller which is capable of performing both roles of the tag and the anchor in the above-described TWR ranging method. Specifically, there are provided the UWB communication section 218 appearing in FIG. 2, the UWB communication section 1273 appearing in FIG. 3, the UWB communication controller 406 appearing in FIG. 4, and the UWB communication controller 506 appearing in FIG. 5. In response to requests from respective applications (such as the image forming apparatus cooperative application 401 and the print application 501, appearing in FIGS. 4 and 5, respectively), frames are transmitted and received and calculation processing is performed, as described above, whereby a distance between the self- apparatus and the ranging target can be measured.

Next, a description will be given of a process performed in the data processing system 1, in which the mobile terminal 101 performs processing for searching for apparatuses which are connected to the same network to which the mobile terminal 101 is connected and are capable of performing BLE communication, and displays apparatuses found by the search on the display 215 as cooperative apparatus candidates.

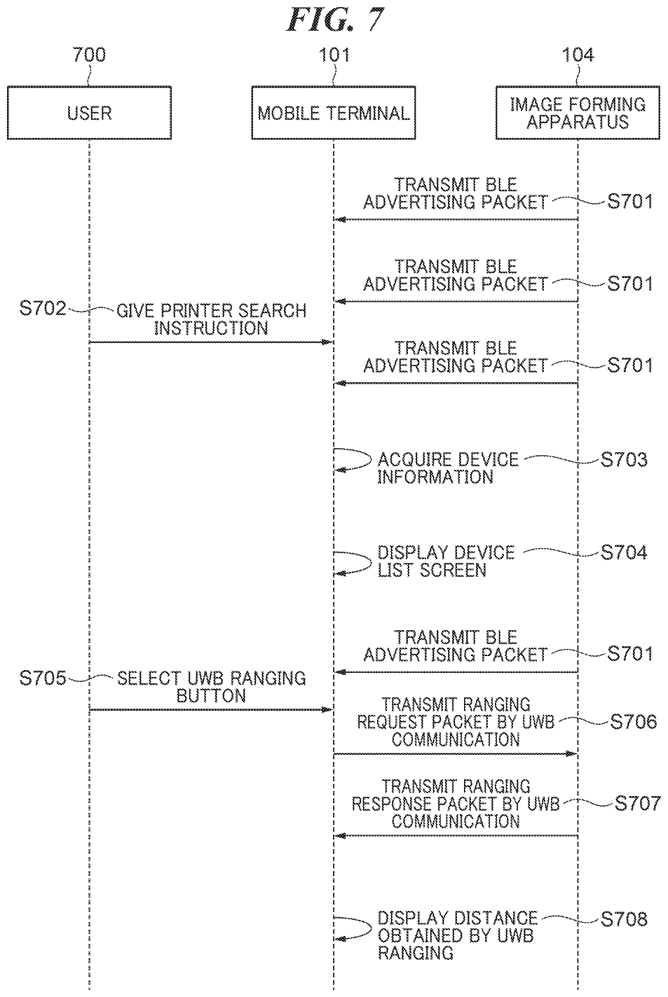

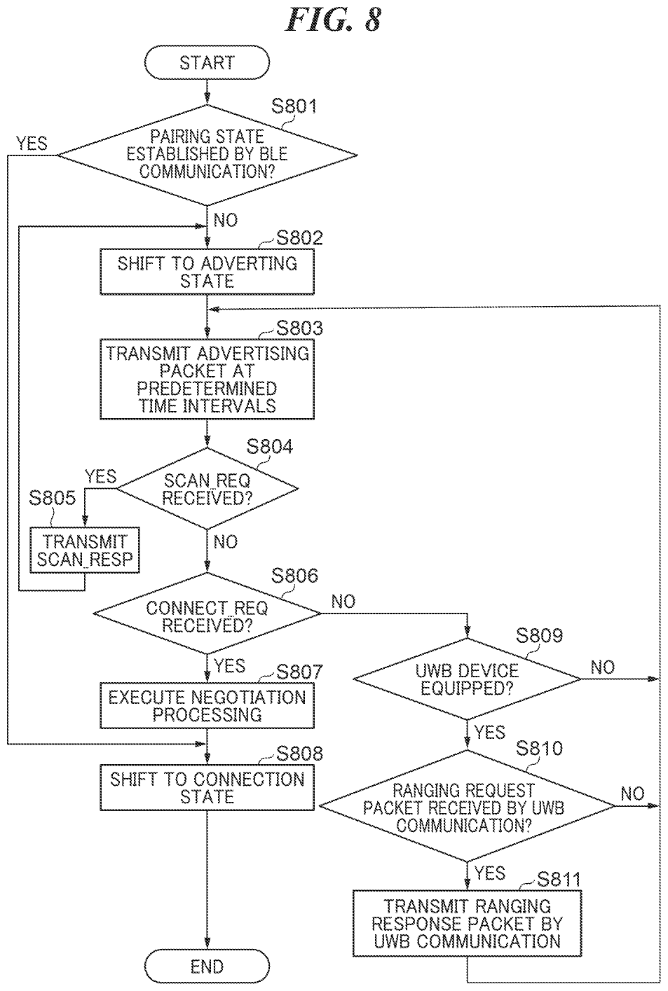

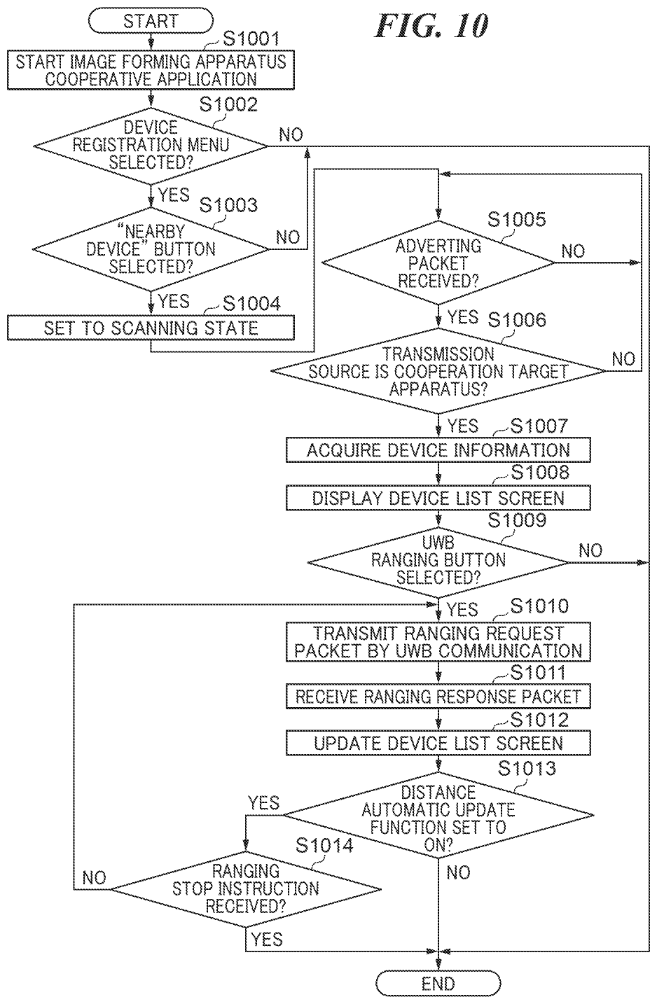

FIG. 7 is a sequence diagram showing a procedure of a cooperative apparatus candidate-displaying process performed in the data processing system 1 according to the present embodiment. Note that in FIG. 7, a process performed by the image forming apparatus 104 out of the image forming apparatuses 104 to 106 and by the mobile terminal 101 will be described by way of example. The entire flow will be described with reference to FIG. 7, and details of processing will be described with reference to a flowchart in FIG. 8 and a flowchart in FIG. 10.

The flow of operations shown in the sequence diagram in FIG. 7 is realized by the hardware and software components forming the mobile terminal 101 and the image forming apparatus 104, shown in FIGS. 2 to 5. Note that in the mobile terminal 101, the software components are operated by the CPU 202 executing programs loaded in the RAM 204. In the image forming apparatus 104, the software components are operated by the CPU 1201 that executes the programs loaded in the RAM 1202.

Note that in the flow of operations shown in the sequence diagram in FIG. 7, it is assumed that a user 700 carrying the mobile terminal 101 is in the WPAN where the mobile terminal 101 can perform BLE communication with the image forming apparatuses 104 to 106.

Referring to FIG. 7, the image forming apparatus 104 broadcasts a BLE advertising packet (S701). The advertising packet includes device information and the like of the image forming apparatus 104. The structure of the advertising packet will be described hereinafter. Note that the image forming apparatus 104 periodically broadcasts the BLE advertising packet until establishment (pairing) of BLE communication is completed.

The mobile terminal 101 starts the image forming apparatus cooperative application 401 according to an instruction for starting the image forming apparatus cooperative application 401, which is received from the user 700. Then, when the user 700 gives a printer search instruction to the mobile terminal 101 (S702), the mobile terminal 101 is enabled to respond to the advertising packet transmitted from the image forming apparatus 104. The mobile terminal 101 having received the advertising packet transmitted from the image forming apparatus 104 in this state recognizes that the received advertising packet is a packet transmitted from a cooperation target apparatus of the image forming apparatus cooperative application 401.

Then, the mobile terminal 101 acquires the device information of the image forming apparatus 104 from the received advertising packet (S703). For example, in a case where the image forming apparatus 104 is equipped with the UWB communication function, UWB tag information used for UWB communication is included in this device information.

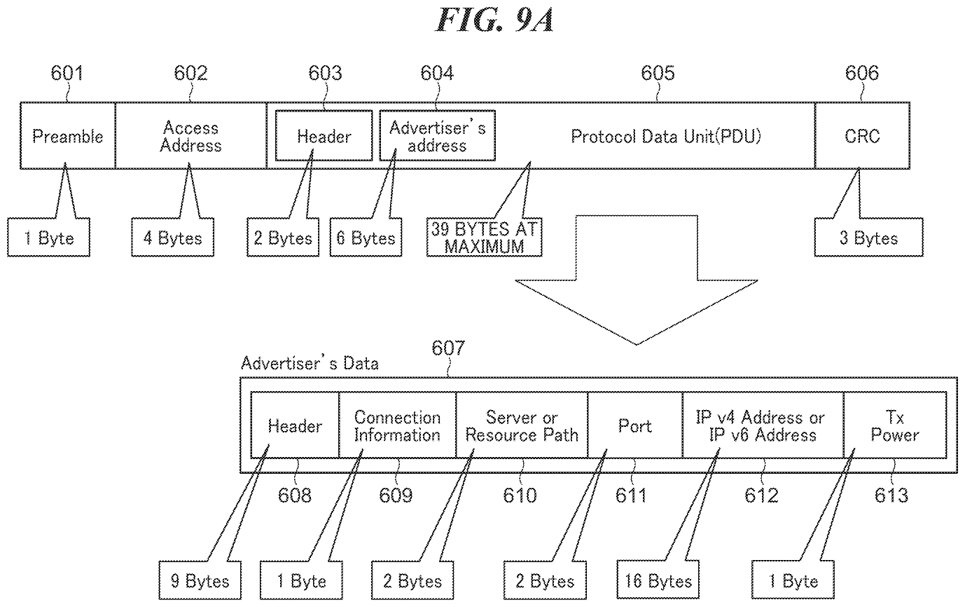

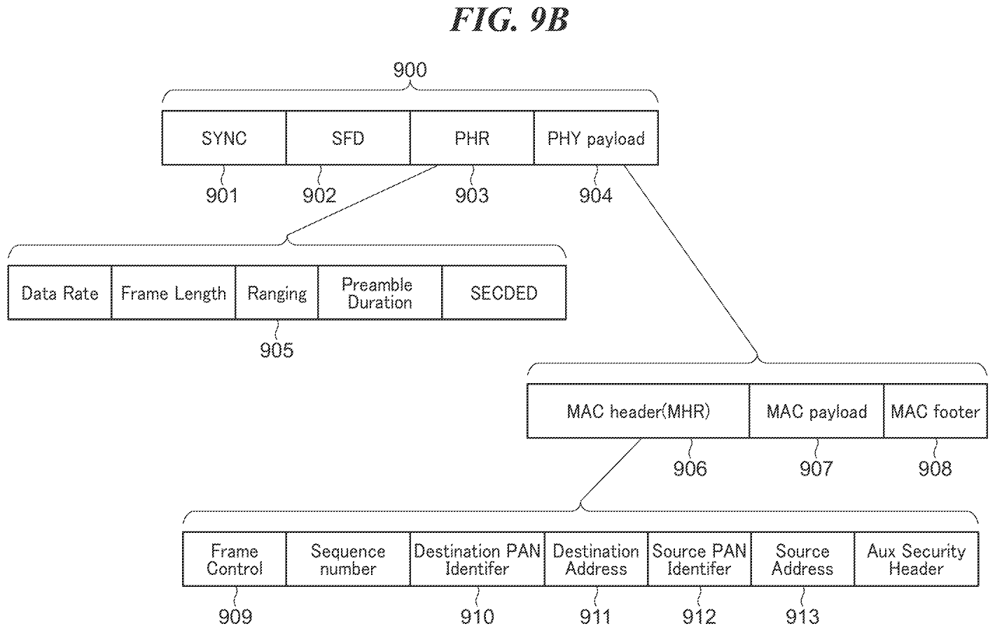

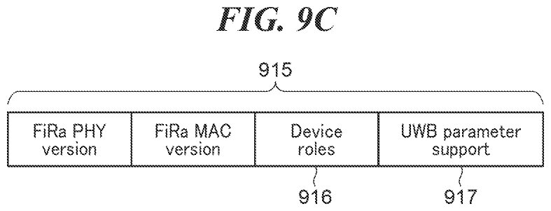

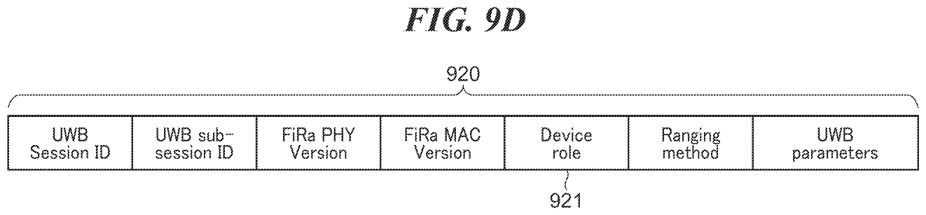

The UWB tag information is information, including at least a PAN ID, respective addresses of a packet transmission source and a packet transmission destination, and an IEEE 802-based address which is uniquely allocated to a wireless terminal for enabling unique identification of the wireless terminal. Note that the PAN ID is an abbreviation of a Personal Area Network ID and is an ID, defined by IEEE 802.15.4z, for identifying a partner of UWB communication. Further, the communication capability information and the communication setting information, necessary for UWB communication, as shown in FIGS. 9B, 9C, and 9D, described hereinafter, can be included in a GATT communication profile (Generic ATTribute Profile). Note that communication of the mobile terminal 101 with the image forming apparatuses 104 and 106 is performed using the communication control based on the “Common Service Management Layer” of the FiRa consortium defined by the specification of IEEE 802.15.4 or the Apple's “Nearby Interaction Protocol” by way of example, and as the information for identifying a communication partner of UWB communication in these communication protocol specifications, the UWB tag information is used. These standards have a property that a UWB wireless chip consumes more energy than wireless chips using other wireless techniques. Therefore, before performing UWB communication, to detect a nearby UWB device, information necessary for UWB communication, such as UWB communication capability and communication settings, is exchanged by using a secondary channel (by BLE communication in most cases).

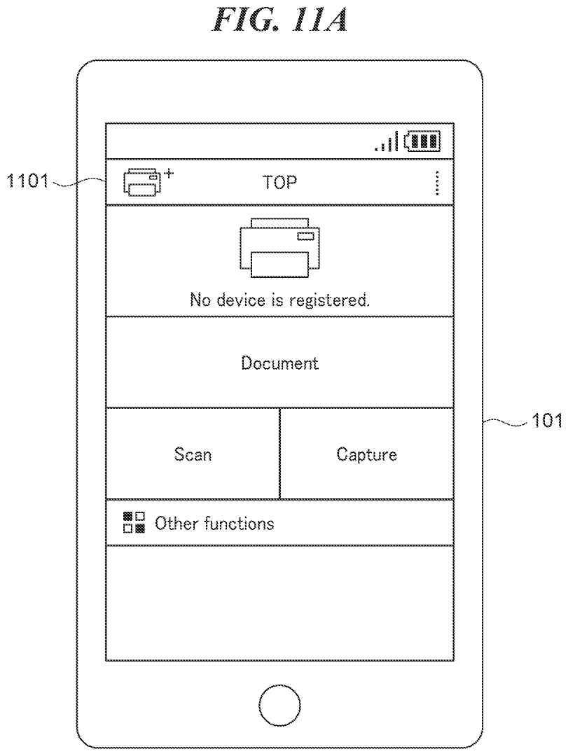

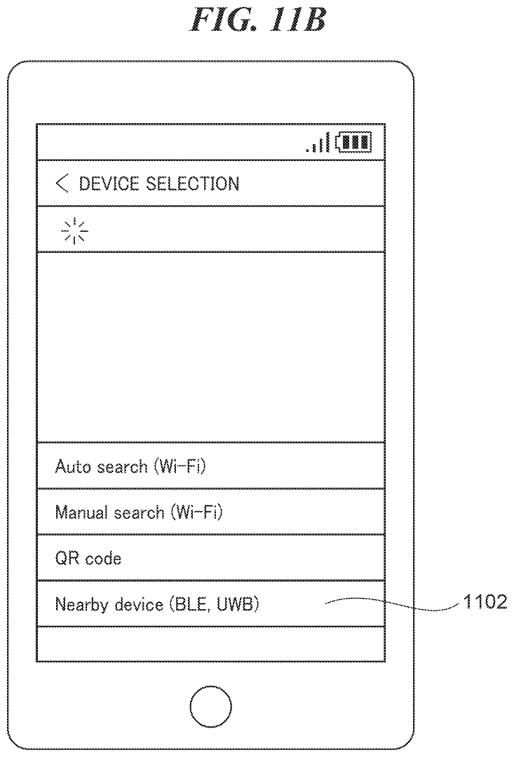

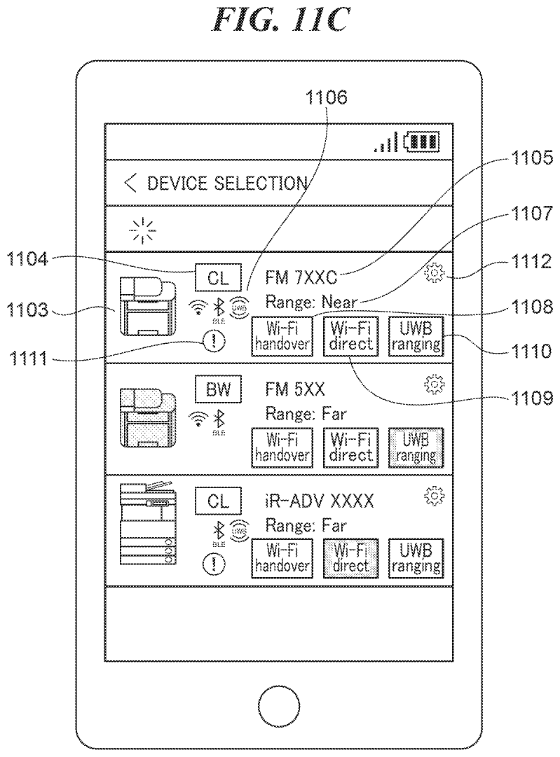

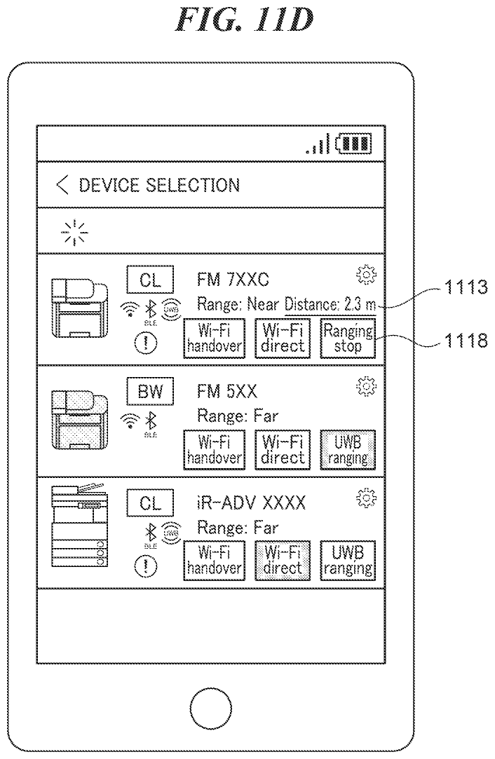

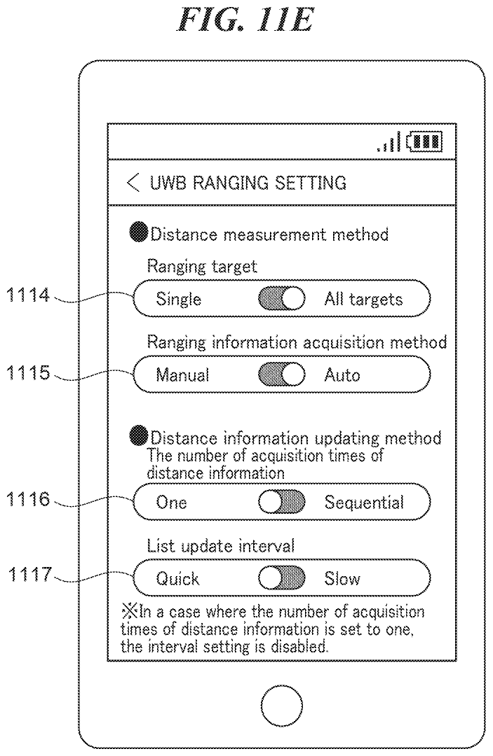

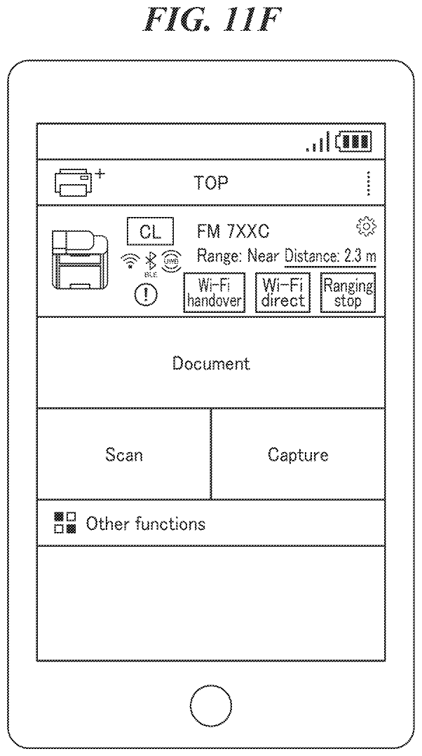

Further, the mobile terminal 101 causes a device list screen, described hereinafter with reference to FIG. 11C, to be displayed on the display 215 based on the acquired device information (S704). The device list screen includes UWB ranging buttons 1110, referred to hereinafter, each for instructing execution of UWB ranging for measuring a distance between the mobile termina 101 and the image forming apparatus 104.

When the user 700 selects the UWB ranging button 1110 of the image forming apparatus 104 as a ranging target (S705), the mobile terminal 101 transmits a ranging request packet to the image forming apparatus 104 by UWB communication based on the UWB tag information acquired in the S704 (S706).

The image forming apparatus 104 having received the ranging request packet transmits a ranging response packet to the mobile terminal 101 by UWB communication (S707). The mobile terminal 101 having received the ranging response packet calculates a distance based on the TWR ranging method shown in FIG. 6 and causes the calculated distance to be displayed on the display 215 (S708), followed by terminating the present process.

The above-described process is the entire flow of operations characterizing the present invention, in which the user 700 acquires the accurate information of distance from the image forming apparatus 104 via the mobile terminal 101. Note that although in the flow of operations in the sequence diagram shown in FIG. 7, the distance information is acquired by performing UWB ranging only once when the user 700 selects a UWB ranging button 1110, this is not limitative. For example, after the distance information is acquired by performing the UWB ranging when the user 700 selects a UWB ranging button 1110, the distance information can be updated by periodically performing the UWB ranging at predetermined time intervals. The detailed operation of this configuration will be described hereinafter with reference to FIG. 10.

FIG. 8 is a flowchart of a BLE communication control process performed by the image forming apparatus 104 appearing in FIG. 1. The BLE communication control process in FIG. 8 is realized by the CPU 1201 executing a program loaded from the ROM 1203 or the HDD 1204 into the RAM 1202. The hardware shown in FIG. 3, including the BLE communication section 1272 and the like, is controlled based on this program.

Referring to FIG. 8, first, the CPU 1201 determines whether or not the image forming apparatus 104 is in a paring state established by BLE communication (S801). In the step S801, for example, in a case where the BLE communication section 1272 has established BLE communication with an apparatus equipped with the BLE communication function, such as the mobile terminal 101, it is determined that the image forming apparatus 104 is in a paring state established by BLE communication. In this case, the BLE communication control process proceeds to a step S808, described hereinafter. On the other hand, in a case where the BLE communication section 1272 has not established BLE communication with an apparatus equipped with the BLE communication function, it is determined that the image forming apparatus 104 is not in a paring state established by BLE communication. In this case, the BLE communication control process proceeds to a step S802.

In the step S802, the CPU 1201 shifts the image forming apparatus 104 to an advertising state in which it periodically transmits an advertising packet. Then, the CPU 1201 controls the BLE communication section 1272 to broadcast the advertising packet at predetermined time intervals (S803) (as performed in the step S701, for example). This advertising packet includes a model name of the image forming apparatus 104 and information indicating whether or not the image forming apparatus 104 can perform color printing. Further, the advertising packet includes information indicating available wireless communication functions, and the UWB tag information as well when the apparatus supports UWB communication.

Then, the CPU 1201 determines whether or not a scan request (SCAN_REQ) for requesting detailed device information of the image forming apparatus 104, which is not included in the advertising packet, has been received from an apparatus having received the advertising packet (S804). For example, in a case where an apparatus having received the advertising packet necessitates information other than the information included in the advertising packet to use a predetermined function, the apparatus transmits SCAN_REQ to the image forming apparatus 104. If it is determined in the step S804 that SCAN_REQ has been received, the CPU 1201 transmits a scan response (SCAN_RESP) including the detailed device information to the transmission source of the received SCAN_REQ (S805). Then, the BLE communication control process returns to the step S802.

If it is determined in the step S804 that SCAN_REQ has not been received, the CPU 1201 determines whether or not a connection request (CONNECT_REQ) for requesting connection of BLE communication has been received (S806).

If it is determined in the step S806 that CONNECT_REQ has been received, the CPU 1201 performs negotiation processing with an apparatus as the transmission source of CONNECT_REQ (S807). Then, the CPU 1201 shifts the image forming apparatus 104 to a connection state (S808). As a result, the image forming apparatus 104 has established BLE communication with the apparatus as the transmission source of CONNECT_REQ to complete pairing. Then, the BLE communication control process is terminated. In the connection state, transmission of the advertising packet is stopped, and when the image forming apparatus 104 is released from the connection state, the step S802 et seq. are executed after the step S801. Note that although as processing after establishing BLE communication, a variety of configurations can be envisaged by the image forming apparatus cooperative application 401, this is not a feature of the present invention, and hence description thereof is omitted.

If it is determined in the step S806 that CONNECT_REQ has not been received, the CPU 1201 determines whether or not a UWB device is equipped (S809). As shown in FIG. 3, since the image forming apparatus 104 includes the UWB communication section 1273 which is a UWB device, it is determined in the step S809 that the UWB device is equipped. If it is determined that a UWB device is equipped, the BLE communication control process proceeds to a step S810. Thus, in a case where an image forming apparatus equipped with a UWB device (such as the image forming apparatuses 104 and 106) executes the BLE communication control process in FIG. 8, the BLE communication control process proceeds to the step S810. On the other hand, in a case where an image forming apparatus which is not equipped with a UWB device, such as the image forming apparatus 105, executes the BLE communication control process in FIG. 8, the BLE communication control process returns to the step S803.

In the step S810, the CPU 1201 determines whether or not a ranging request packet has been received by UWB communication. If it is determined in the step S810 that no ranging request packet has been received by UWB communication, the BLE communication control process returns to the step S803. If it is determined in the step S810 that a ranging request packet has been received by UWB communication, the CPU 1201 transmits a ranging response packet to the transmission source of this ranging request packet by UWB communication (S811). Note that the processing in the step S811 corresponds to the data response (transmission of the response frame) in the UWB ranging method, described with reference to FIG. 6. After that, the BLE communication control process returns to the step S803.

The BLE communication control process described above with reference to FIG. 8 enables the mobile terminal 101 having received the advertising packet from the image forming apparatus 104 to handle the device information of the image forming apparatus 104 by the image forming apparatus cooperative application 401. Further, the mobile terminal 101 is enabled to perform UWB ranging for measuring a distance between the mobile terminal 101 and the image forming apparatus 104 based on the UWB tag information included in this device information.

Next, the structure of the data transmitted and received by BLE communication and UWB communication will be described.

FIG. 9A is a diagram showing the structure of the BLE advertising packet transmitted from each of the image forming apparatuses 104 to 106 appearing in FIG. 1, which is equipped with the UWB communication function.

Although there are a plurality of forms of the BLE advertising packets transmitted from the image forming apparatuses 104 to 106, it is assumed here that the advertising packet of the form of Apple's Air Print Bluetooth Beacon is transmitted. Further, the BLE advertising packet is radio beacon data transmitted as a so-called beacon signal by broadcast transmission, and is transmitted at intervals of several milliseconds or several seconds.

First, at the top of the BLE advertising packet, Preamble 601 used by a BLE wireless device for determining a signal reading timing is formed by 1 byte. Next, Access Address 602 for inputting a value indicating that the present packet is a BLE advertising packet is formed by 4 bytes. Next, as a real data area, Protocol Data Unit (PDU) 605 is formed by 39 bytes at the maximum. However, the PDU 605 includes Header 603 which consumes 2 bytes and Advertiser's address 604 which consumes 6 bytes, and hence the remaining 31 bytes form Advertiser's Data 607 as real data.

As an example of the Advertiser's Data 607, the format of Air Print Bluetooth Beacon will be described with reference to FIG. 9A. First, Header 608 as a common value of Air Print Bluetooth Beacon is formed by 9 bytes. Next, Connection Information 609 indicating information, such as the IP address format and whether an image forming apparatus transmitting an advertising packet is a printer or a print server, is formed by 1 byte. Next, Server or Resource Path 610 indicating ID information of a printer, determined by the server, is formed by 2 bytes. Next, Port 611 indicating a Port number is formed by 2 bytes. Next, IP address (IP v4 Address or IP v6 Address) 612 is formed by 16 bytes. Finally, Tx Power 613 indicating the intensity of a signal transmitted from the beacon is formed by 1 byte. The end of the BLE advertising packet has cyclic redundancy check (CRC) 606 for code error detection, which is formed by 3 bytes. Thus, the whole advertising packet is formed.

The example of the advertising packet is described as above. Note that BLE communication is used as the secondary channel so as to exchange the necessary information before UWB communication, as described above, and hence, for example, the UWB tag information and the UWB communication setting information can be included in the advertising packet.

FIG. 9B is a diagram showing a packet specification used in the UWB ranging in the data processing system 1. The packet specification for UWB ranging is defined as a structure of a UWB frame 900 in the physical layer and the data link layer (MAC) in the general communication protocol stack.

The UWB frame 900 is formed by fields of SYNC 901 for holding a preamble for synchronizing between a transmitting device and a receiving device, SFD 902 for holding a value indicating a boundary between the preamble and a PHY header, PHR 903, and PHY payload 904.

The PHR 903 is a field for holding the PHY header, and the PHY payload 904 is a field for holding a PHY payload.

The PHR 903 further has a filed of Ranging 905 for holding a flag for identifying whether or not the frame is a frame issued to perform ranging. For example, in a ranging request packet transmitted by the mobile terminal 101 or the image forming apparatus 104 to perform ranging, the flag of Ranging 905 of the above-mentioned frame structure is set to 1 by the UWB communication controller 406 or 506 (see FIG. 4 or 5).

Further, the PHY payload 904 is formed by MHR 906, MAC payload 907, and MAC footer 908, as shown in FIG. 9B.

The MHR 906 is a field for holding the MAC header and includes fields 909 to 913, as shown in FIG. 9B.

Reference numeral 909 indicates a field of Frame Control indicating the frame format used for control of the frame in the data link layer (MAC). Reference numeral 910 indicates a field of Destination PAN Identifier indicating a packet transmission destination PAN ID. Reference numeral 911 indicates a field of Destination Address indicating an address of a packet transmission destination.

Further, reference numeral 912 indicates a field of Source PAN Identifier indicating a packet transmission source PAN ID. Reference numeral 913 indicates a field of Source Address indicating an address of a packet transmission source.

As the PAN ID and the address information, held by these fields 909 to 913, the information unique to the apparatus is set by the UWB communication controllers 406 and 506 (see FIGS. 4 and 5). In the mobile terminal 101 in the data processing system 1, address information acquired from the device information transmitted from the image forming apparatus 104 is set in the fields 910 and 911.

In doing this, in the image forming apparatus 104, the UWB communication controller 506 analyzes the field of Ranging 905 and the fields 905 to 908 indicating the PAN IDs and the addresses of the packet transmission source and the transmission destination, and so forth, of a frame forming the received ranging request packet. The UWB communication controller 506 generates a frame to which information of the time required to analyze the frame and perform the response processing is added, and transmits a ranging response packet to the mobile terminal 101.

FIG. 9C is a diagram showing a specification of a communication capability message 915 in the communication protocol definition (CSML) defined by FiRa, which can be applied to the UWB ranging in the data processing system 1. The communication capability message 915 is a communication message in a network layer and a transport layer in the communication protocol stack. The information concerning compatibility between FiRa devices and communication capability is exchanged by using a communication channel of another band, such as BLE or NFC.

The mobile terminal 101 and the image forming apparatus 104 each have a communication protocol stack installed therein which is a component of the BLE communication controller 405 or 505 (see FIG. 4 or 5) and processes the communication capability message 915 as part of an API called by an application of an upper layer.

As the interface, the communication capability message 915 includes a physical layer version of FiRa PHY version and a MAC layer version of FiRa MAC version, defined by FiRa.

Further, the communication capability message 915 includes Device roles 916 and UWB parameter support 917.

The Device roles 916 indicates the role of UWB communication, i.e. which of the function of an anchor as the execution entity of ranging or the function of a tag as the ranging target is supported. Further, the UWB parameter support 917 includes settings related to the supported ranging, such as Ranging Methods.

As for the image forming apparatus 104 and the mobile terminal 101, Device roles 916 indicates that they each support both modes of the anchor and the tag. Further, the image forming apparatus 104 and the mobile terminal 101 support at least TWR as the Ranging Methods.

FIG. 9D is a diagram showing a specification of a communication configuration message 920 in the communication protocol definition (CSML) defined by FiRa, which can be applied to the UWB ranging in the data processing system 1. UWB communication settings in the communication configuration message 920 are determined by the exchange of the above-described communication capability message 915. As the UWB communication settings, for example, the role and the ranging method for performing the UWB communication between the image forming apparatus 104 and the mobile terminal 101 are determined. The communication configuration message 920 including these setting information items is exchanged between the image forming apparatus 104 and the mobile terminal 101.

In determining this UWB communication setting, the image forming apparatus 104 and the mobile terminal 101 perform negotiation between the FiRa devices.

In the data processing system 1, mediation of the roles of the anchor and the tag as UWB devices is performed based on requests from respective applications of the mobile terminal 101 and the image forming apparatus 104. In the communication configuration message 920, a field of Device role 921 indicating a role to be determined by this mediation is provided. Specifically, first, the image forming apparatus cooperative application 401 of the mobile terminal 101 transmits a ranging request to the ranging target, such as the image forming apparatuses 104 and 106. In a case where the ranging target is the image forming apparatus 104, this ranging request starts the above-mentioned mediation between the image forming apparatus 104 and the mobile terminal 101, and the mediation of the roles as the UWB devices is performed between the UWB communication controllers 406 and 506 in the respective platforms. The mobile terminal 101 transmits and receives the communication configuration message 920 so as to set the role of the self-apparatus to the anchor so as to become the execution entity of ranging and performs ranging after setting its role to the anchor. In the present embodiment, ranging is performed from the mobile terminal 101, and hence the role of the mobile terminal 101 is the anchor, and the role of the image forming apparatuses 104 and 106 is the tag.

Thus far, the structure of the data transmitted and received in BLE communication and UWB communication is described.

Next, a description will be given of a process performed by the mobile terminal 101, for searching for image forming apparatuses that are connected to the same network as the mobile terminal 101 and are capable of performing BLE communication, and for displaying a list of a plurality of image forming apparatuses found by the search.

FIG. 10 is a flowchart of a list display control process performed by the mobile terminal 101 appearing in FIG. 1. The list display control process in FIG. 10 is realized by the CPU 202 executing a program loaded, for example, from the ROM 203 into the RAM 204. The hardware shown in FIG. 2, including the UWB communication section 218, the BLE communication section 213, and so forth, is controlled based on this program. The list display control process in FIG. 10 is executed when an instruction for starting the image forming apparatus cooperative application 401 is received from a user. Note that in the present embodiment, it is assumed that the image forming apparatuses 104 to 106 are arranged within the WPAN in which the mobile terminal 101 carried by the user can perform BLE communication.

Referring to FIG. 10, first, the CPU 202 starts the image forming apparatus cooperative application 401 according to a start instruction received from the user (S1001). When the image forming apparatus cooperative application 401 is started, a top screen shown in FIG. 11A is displayed on the display 215 of the mobile terminal 101. Note that the user can operate the function of the image forming apparatus cooperative application 401 by touching the touch panel 216 mounted on the same surface as the display 215.

The top screen shown in FIG. 11A is a screen for selecting a predetermined function of executing processing in cooperation with the image forming apparatuses 104 to 106 and includes a device registration menu 1101 for shifting the screen to a device selection screen shown in FIG. 11B. The user can select, for example, a print function or a scan function from the top screen, and further, the user can also search for and register a device to be used. Note that the configuration of the top screen shown in FIG. 11A is an example and is not limited to this.

Then, the CPU 202 determines whether or not the user has selected the device registration menu 1101 (S1002). If it is determined in the step S1002 that the user has not selected the device registration menu 1101, the list display control process is terminated. If it is determined in the step S1002 that the user has selected the device registration menu 1101, the CPU 202 displays the device selection screen shown in FIG. 11B on the display 215. This device selection screen includes a “nearby device” button 1102 for giving a printer search instruction.

Then, the CPU 202 determines whether or not the user has selected the “nearby device” button 1102 (S1003). If it is determined in the step S1003 that the user has not selected the “nearby device” button 1102, the list display control process is terminated.

If it is determined in the step S1003 that the user has selected the “nearby device” button 1102, the CPU 202 sets the BLE communication section 213 to a scanning state so as to search for image forming apparatuses around the mobile terminal 101, which can perform BLE communication (S1004). With this, the mobile terminal 101 is enabled to respond to advertising packets broadcasted, for example, from the image forming apparatuses 104 to 106 at predetermined time intervals.

Then, the CPU 202 waits until an advertising packet broadcasted from an image forming apparatus which can perform BLE communication is received. When an advertising packet is received (YES to a step S1005), the CPU 202 determines whether or not the transmission source of the advertising packet is a cooperation target apparatus of the image forming apparatus cooperative application 401 (S1006). The cooperation target apparatus of the image forming apparatus cooperative application 401 is an apparatus which is connected to the same network as the mobile terminal 101 and is capable of performing BLE communication, for example, any of the image forming apparatuses 104 to 106. Within a space, such as an office, it is also assumed that the mobile terminal 101 receives an advertising packet transmitted from an apparatus other than the cooperation target apparatus of the image forming apparatus cooperative application 401. For this reason, in the present embodiment, the determination processing in the step S1006 is performed. In the step S1006, the determination processing is performed based on, for example, an address and a universally unique identifier (UUID) for identifying an advertiser, included in the advertising packet having the data structure described with reference to FIG. 9.

If it is determined in the step S1006 that the transmission source of the advertising packet is not a cooperation target apparatus of the image forming apparatus cooperative application 401 (any of the image forming apparatuses 104 to 106, for example), the list display control process returns to the step S1005.

If it is determined in the step S1006 that the transmission source of the advertising packet is a cooperation target apparatus of the image forming apparatus cooperative application 401 (any of the image forming apparatuses 104 to 106, for example), the list display control process proceeds to a step S1007.

In the step S1007, the CPU 202 acquires device information from the received advertising packet. This device information includes not only model information and a status of the apparatus as the transmission source of the advertising packet, but also information indicating available wireless communication functions, BLE radio intensity information, UWB tag information, and UWB communication setting information. The acquired device information is stored in the RAM 204 and used for a variety of functions of the image forming apparatus cooperative application 401. Note that the acquired device information can be stored in the ROM 203 so as to make it possible to call the device information afterwards. Further, in a case where necessary information is not included in the advertising packet, detailed device information can be acquired by transmitting a scan request (SCAN_REQ) packet to the transmission source of the advertising packet as a response.

Then, the CPU 202 displays the device list screen shown in FIG. 11C on the display 215 based on the acquired device information (S1008). On the device list screen, there is displayed a list of information on apparatuses which are transmission sources of the advertising packets received by the mobile terminal 101 and are cooperation target apparatuses of the image forming apparatus cooperative application 401. FIG. 11C displays a list of information on the image forming apparatuses 104 to 106.

On the device list screen, for example, an icon illustrating an outer shape of the image forming apparatus (an icon 1103, for example), a symbol indicating whether or not color printing and/or monochrome printing (a symbol 1104, for example), and a model name (a model name 1105, for example) are displayed for each image forming apparatus. Further, on the device list screen, a wireless communication compatibility icon indicating an available wireless communication function (an icon 1106, for example), and so forth are displayed for each image forming apparatus. Thus, by displaying the wireless communication compatibility icon for each image forming apparatus, the user can easily know what kind of wireless communication function can be used by each image forming apparatus.

Further, on the device list screen, distance information obtained by ranging performed by BLE communication (distance information 1107, for example) is indicated as Near, Far, or Immediate for each image forming apparatus. Note that in the ranging performed by BLE communication, a received signal strength indicator (RSSI) method using the radio intensity of the received advertising packet is employed. Further, on the device list screen, for example, a Wi-Fi handover button (a button 1108, for example) for changing connection of Wi-Fi communication and a Wi-Fi direct button (a button 1109, for example) are also displayed for each image forming apparatus.

Further, on the device list screen, the UWB ranging button 1110 for instructing execution of UWB ranging is displayed for each image forming apparatus. As for an apparatus that is not equipped with the UWB communication function, such as the image forming apparatus 105, the UWB ranging button 1110 therefor is displayed in a grayed-out state so as to disable a user from selecting the UWB ranging button 1110. Note that on the device list screen, the UWB ranging button 1110 can be displayed only for an apparatus equipped with the UWB communication function.

Further, on the device list screen, in a case where there is a push notification notifying, for example, toner-out, paper-out, and paper jam, a status notification (a notification 1111, for example) is displayed. Further, on the device list screen, a details-setting button (a button 1112, for example) for confirming detailed setting information of each image forming apparatus is displayed for each image forming apparatus. Note that in a case where a target model, an icon, and the like are added, for example, the image forming apparatus cooperative application 401 is updated, or the display of the device list screen is controlled in cooperation with a network server, not shown.

Then, the CPU 202 determines whether or not the user has selected any UWB ranging button 1110 (S1009). If it is determined in the step S1009 that the user has not selected any UWB ranging button 1110, the list display control process is terminated. If it is determined in the step S1009 that the user has selected a UWB ranging button 1110, the list display control process proceeds to a step S1010.

In the step S1010, the CPU 202 transmits a ranging request packet to the image forming apparatus corresponding to the selected UWB ranging button 1110 by UWB communication. For example, in a case where the user has selected the UWB ranging button 1110 of the image forming apparatus 104 on the device list screen, the CPU 202 acquires the device information of the image forming apparatus 104 from a plurality of device information items stored in the RAM 204 in the step S1007. Further, the CPU 202 controls the UWB communication section 218 to transmit the ranging request packet to the image forming apparatus 104 based on the UWB tag information included in this device information.

Then, the CPU 202 receives a ranging response packet from the transmission destination of the ranging request packet (S1011). The CPU 202 calculate a distance based on the TWR ranging method described with reference to FIG. 6. Then, the CPU 202 updates the device list screen (S1012). FIG. 11D is a diagram showing an example of the device list screen updated by the processing in the step S1012. On the device list screen shown in FIG. 11D, for example, distance information 1113 indicating the distance calculated based on the TWR ranging method described with reference to FIG. 6 is displayed as the information of the image forming apparatus 104 corresponding to the selected UWB ranging button 1110.

Then, the CPU 202 determines whether or not a distance automatic update function is set to on (S1013). In the present embodiment, the user can set on/off of the distance automatic update function in advance by operating a toggle button 1116 on a UWB ranging-setting screen shown in FIG. 11E. In a case where the toggle button 1116 is set to “one time”, the distance automatic update function is set to off. In this case, for example, a distance is calculated based on the TWR ranging method shown in FIG. 6 according to user selection of the UWB ranging button 1110, and the distance information 1113 indicating the calculated distance is displayed on the device list screen. That is, the distance information 1113 is prevented from being periodically updated. On the other hand, in a case where the toggle button 1116 is set to “sequential”, the distance automatic update function is set to on. In this case, after the distance information 1113 is displayed on the device list screen according to user selection of the UWB ranging button 1110, the distance information 1113 is updated at predetermined time intervals. By providing the toggle button 1116, it is possible to reflect user's intention to whether or not to periodically update the distance information. Note that in the present embodiment, the user can set the above-mentioned predetermined time interval in advance by operating a toggle button 1117 on the UWB ranging-setting screen shown in FIG. 11E. In a case where the toggle button 1117 is set to “quick”, the distance information 1113 is updated, for example, at intervals of 500 milliseconds. On the other hand, in a case where the toggle button 1117 is set to “slow”, the distance information is updated, for example, at intervals of 3 seconds.

If it is determined in the step S1013 that the distance automatic update function is set not to on, but to off, the list display control process is terminated. If it is determined in the step S1013 that the distance automatic update function is set to on, the list display control process proceeds to a step S1014.

In the step S1014, the CPU 202 determines whether or not a ranging stop instruction has been received from the user. In the present embodiment, the ranging stop instruction can be provided by selecting a ranging stop button 1118 on the device list screen shown in FIG. 11D or selecting a button (not shown) for terminating the image forming apparatus cooperative application 401.

If it is determined in the step S1014 that the ranging stop instruction has not been received from the user, when the time corresponding to the setting of the toggle button 1117 elapses, the list display control process returns to the step S1010, and the processing for updating the distance information is executed. Thus, in the present embodiment, in a case where the distance automatic update function is set to on, the distance information 1113 is updated at the predetermined time intervals set by the toggle button 1117 on the UWB ranging-setting screen shown in FIG. 11E until the ranging stop instruction is received from the user.

If it is determined in the step S1014 that the ranging stop instruction has been received from the user, the list display control process is terminated.

According to the present embodiment, in a case where the transmission source of the advertising packet is an image forming apparatus supporting UWB communication which makes it possible to acquire higher-accuracy distance information than BLE communication, the device list screen including the UWB ranging button 1110 is displayed on the display 215. With this, it is possible to easily use the UWB ranging function which makes it possible to acquire distance information with higher accuracy, for an image forming apparatus equipped with the UWB communication function.

Further, in the above-described embodiment, in a case where a plurality of different advertising packets have been received from a plurality of image forming apparatuses, UWB ranging buttons 1110 are selectively displayed for image forming apparatuses equipped with the UWB communication function, on the device list scree. With this, it is possible to use the UWB ranging function only for image forming apparatuses supporting UWB communication, from among the plurality of image forming apparatuses.

Further, in the above-described embodiment, in a case where a plurality of different advertising packets have been received from a plurality of image forming apparatuses equipped with the UWB communication function, a plurality of UWB ranging buttons 1110 associated with the plurality of image forming apparatuses, respectively, are displayed on the device list screen. With this, it is possible to use the UWB ranging function only for a specific image forming apparatus of the plurality of image forming apparatuses equipped with the UWB communication function, and thereby suppress the processing load required for the UWB ranging to the minimum.

Further, in the present embodiment, the distance information 1113 obtained by the UWB ranging is displayed on the device list screen, and hence the user can know highly accurate distance information between the mobile terminal 101 and the image forming apparatus, from the device list screen.

Thus, although the present invention has been described with reference to the above-described embodiment, the present invention is not limited to the above-described embodiment. For example, as for an image forming apparatus for which the associated UWB ranging button 1110 has been once selected, the configuration can be such that the updated distance information can be confirmed not from the device list screen, but from the top screen (such as a top screen shown in FIG. 11F).

Further, in the present embodiment, the configuration can be such that the distance information of UWB-supporting devices displayed on the device list screen is displayed without user selection of the UWB ranging button 1110. Note that the UWB-supporting devices are image forming apparatuses equipped with the UWB communication function.

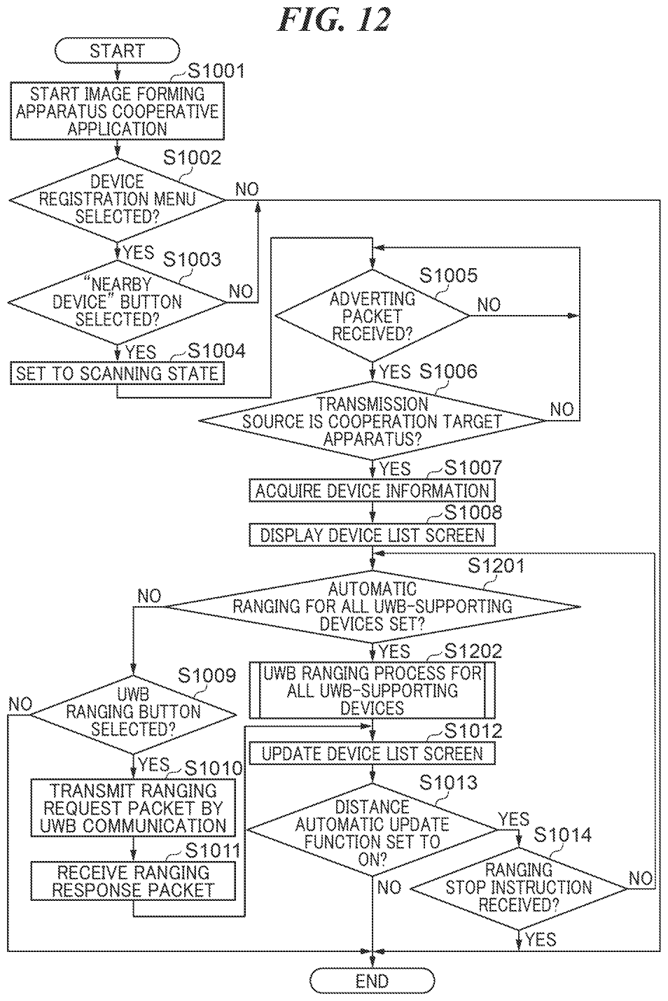

FIG. 12 is a flowchart of a variation of the list display control process performed by the mobile terminal 101 appearing in FIG. 1. Note that the list display control process in FIG. 12 is similar to the above-described list display control process in FIG. 10, and hence the following description will be given specifically of different points from the list display control process in FIG. 10. The list display control process in FIG. 12 is also realized by the CPU 202 executing a program loaded, for example, from the ROM 203 into the RAM 204, similarly to the list display control process described above with reference to FIG. 10. The hardware shown in FIG. 2, including the UWB communication section 218, the BLE communication section 213, and so forth is controlled based on this program. Further, the list display control process in FIG. 12 is also executed when an instruction for starting the image forming apparatus cooperative application 401 is received from the user, similarly to the list display control process in FIG. 10. Note that also in FIG. 12, it is also assumed that the image forming apparatuses 104 to 106 are in the WPAN in which the mobile terminal 101 carried by the user can perform BLE communication.

Referring to FIG. 12, first, the above-described S1001 to S1008 are executed. Then, the CPU 202 determines whether or not automatic ranging for all UWB-supporting devices is set (S1201). In the present embodiment, the user can set the ranging target to one of “single” and “all targets” by operating, in advance, a toggle button 1114 on the UWB ranging-setting screen shown in FIG. 11E. Further, the user can set one of “manual” for performing ranging according to an instruction received from a user and “auto” for performing ranging without receiving an instruction from a user by operating, in advance, a toggle button 1115 on the UWB ranging-setting screen shown in FIG. 11E. In the step S1201, in a case where the toggle button 1114 is set to “all targets” and the toggle button 1115 is set to “auto”, it is determined that automatic ranging for all UWB-supporting devices is set. In this case, the list display control process proceeds to a step S1202. On the other hand, in a case where the toggle button 1114 and the toggle button 1115 are set to settings other than the above-mentioned settings, it is determined that automatic ranging for all UWB-supporting devices is not set. In this case, the list display control process proceeds to the step S1009.

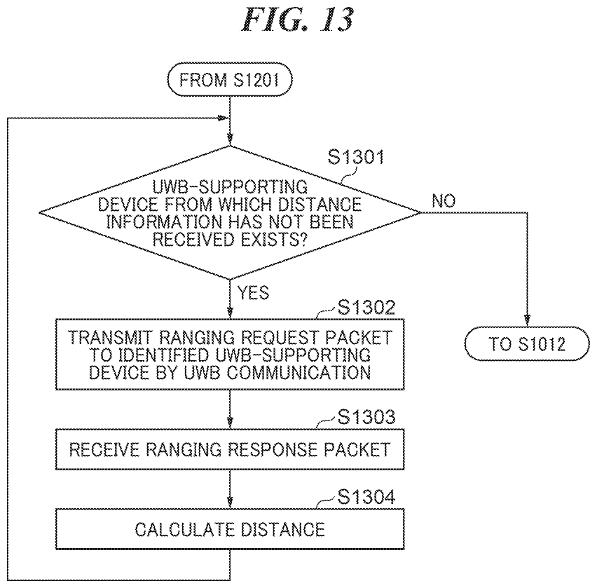

In the step S1202, the CPU 202 performs a UWB ranging process for all UWB-supporting devices, which is described hereafter with reference to FIG. 13.

FIG. 13 is a flowchart of the UWB ranging process for all UWB-supporting devices, which is performed in the step S1202 in FIG. 12.

Referring to FIG. 13, the CPU 202 determines whether or not there is any UWB-supporting device from which the distance information has not been received, among the UWB-supporting devices displayed on the device list screen (S1301). If it is determined in the step S1301 that there is any UWB-supporting device from which the distance information has not been received, the CPU 202 identifies one UWB-supporting device from which the distance information has not been received, among the UWB-supporting devices displayed on the device list screen. The CPU 202 transmits a ranging request packet to the identified UWB-supporting device by UWB communication (S1302). Then, the CPU 202 receives a ranging response packet from the transmission destination of the ranging request packet (S1303). Then, the CPU 202 calculates a distance based on the TWR ranging method described with reference to FIG. 6 (S1304). The distance information obtained in the step S1304 is stored, for example, in the RAM 204. After that, the UWB ranging process in FIG. 13 returns to the step S1301. Thus, it is possible to obtain the distance information by performing the UWB ranging with respect to all UWB-supporting devices displayed on the device list screen.

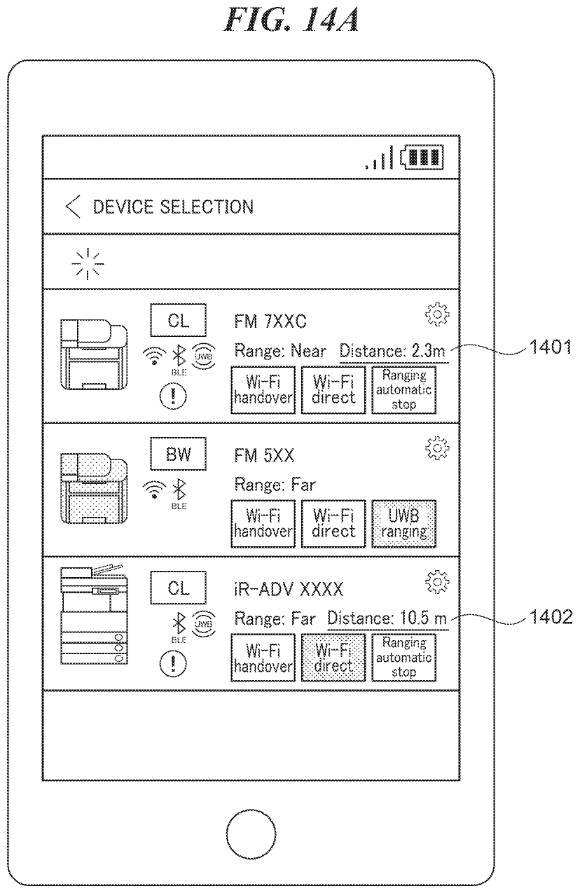

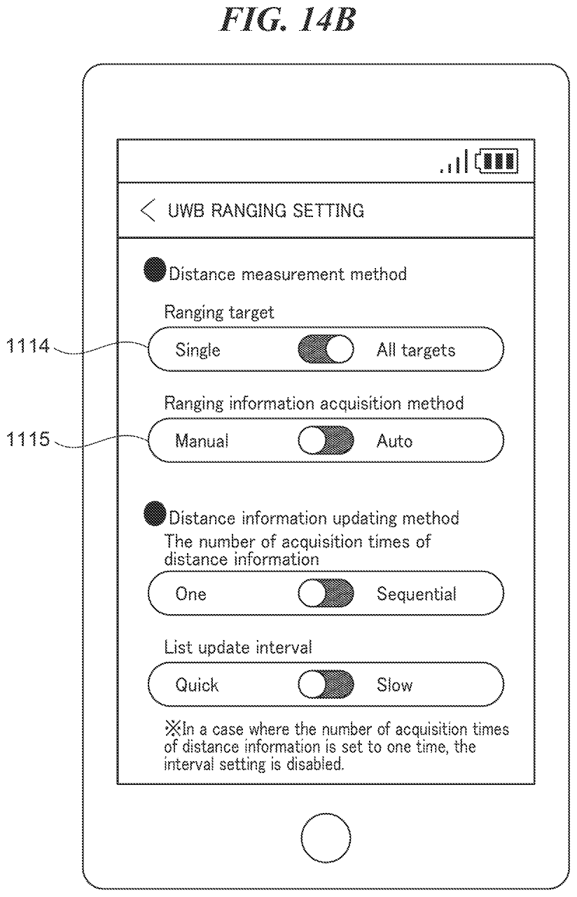

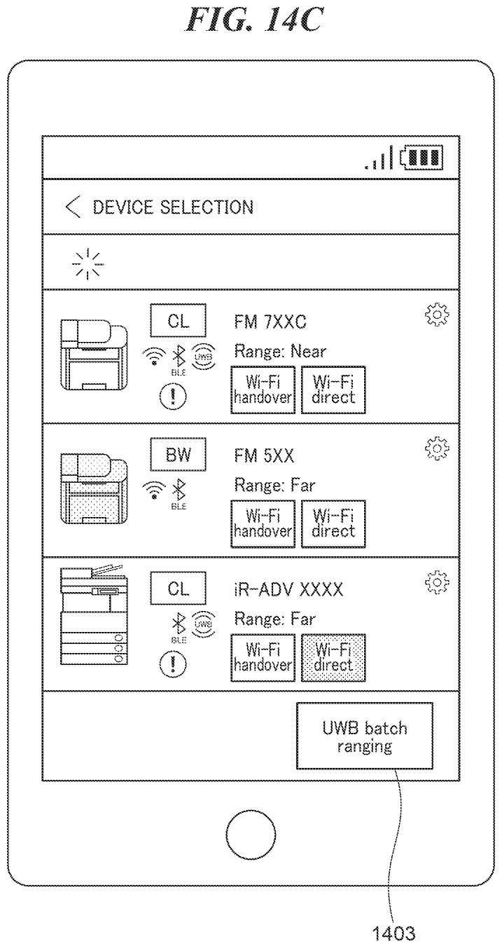

If it is determined in the step S1301 that there is no UWB-supporting devices from which the distance information has not been received, the UWB ranging process in FIG. 13 is terminated, and the list display control process in FIG. 12 proceeds to the step S1012. By executing the update processing in the step S1012, as shown in FIG. 14A, distance information items 1401 and 1402 of the UWB-supporting devices, among the plurality of image forming apparatuses displayed on the device list screen are displayed. Note that the list display control process in FIG. 12 is different from the list display control process in FIG. 10 in that if it is ermined in the step S1014 that the ranging stop instruction has not been received from the user, when the time corresponding to the setting of the toggle button 1117 elapses, the list display control process returns to the step S1201.

In the above-described embodiment, the toggle button 1114 and the toggle button 1115 are provided for prompting a user to set execution of the UWB ranging without selecting a UWB ranging button 1110. With this, even when a user does not select a UWB ranging button 1110, it is possible to display highly accurate distance information between the mobile terminal 101 and the UWB-supporting devices on the device list screen.

Further, in the present embodiment, a UWB batch ranging button for instructing batch ranging for all UWB-supporting devices displayed on the device list screen can be displayed on the device list screen.

For example, as shown in FIG. 14B, in a case where the toggle button 1114 is set to “all targets” and at the same time, the toggle button 1115 is set to “manual”, the device list screen shown in FIG. 14C is displayed in the step S1008. This device list screen includes, not the UWB ranging button associated with each image forming apparatus, but the UWB batch ranging button, denoted by reference numeral 1403. When the UWB batch ranging button 1403 is selected, the above-described UWB ranging process for all UWB-supporting devices in FIG. 13 is executed, and the UWB ranging is performed to obtain the distance information with respect to all of the UWB-supporting devices displayed on the device list screen. These distance information items of all of the UWB-supporting devices are displayed on the device list screen, each, for example, as shown in FIG. 14A.

In the above-described embodiment, the device list screen includes the UWB batch ranging button 1403 for collectively instructing the UWB ranging between the mobile terminal 101 and each of the image forming apparatuses 104 and 106 which support UWB communication. This makes it possible to reduce the user's time and effort when instructing the UWB ranging for a plurality of image forming apparatuses.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-049818 filed Mar. 27, 2023, which is hereby incorporated by reference herein in its entirety.

What is claimed is:

1. An information processing apparatus that executes predetermined processing in cooperation with a cooperation target apparatus, comprising:
a receiving unit configured to receive an advertising packet transmitted by first wireless communication; and
a control unit configured to display a list screen for prompting a user to select the cooperation target apparatus on a display unit of the information processing apparatus based on the advertising packet,
wherein in a case where a transmission source of the advertising packet is an apparatus supporting second wireless communication which makes it possible to acquire distance information with higher accuracy than the first wireless communication, the control unit displays, on the display unit of the information processing apparatus, the list screen including an object for instructing ranging between the information processing apparatus and the transmission source by the second wireless communication.

2. The information processing apparatus according to claim 1, wherein in a case where a plurality of different advertising packets have been received from a plurality of communication apparatuses, the object associated with each of communication apparatuses supporting the second wireless communication, among the plurality of communication apparatuses, is selectively displayed on the list screen.

3. The information processing apparatus according to claim 1, wherein in a case where a plurality of different advertising packets have been received from a plurality of communication apparatuses supporting the second wireless communication, a plurality of the objects associated with the plurality of communication apparatuses, respectively, are displayed on the list screen.

4. The information processing apparatus according to claim 1, wherein the receiving unit receives a plurality of different advertising packets-from a plurality of communication apparatuses supporting the second wireless communication, and
wherein the object is an object for collectively instructing ranging between the information processing apparatus and each of the plurality of communication apparatuses by the second wireless communication.

5. The information processing apparatus according to claim 1, further comprising a ranging unit configured to perform ranging between the information processing apparatus and an apparatus associated with the object by the second wireless communication, according to selection of the object, performed by a user; and
wherein the control unit displays distance information obtained by ranging performed by the second wireless communication on the list screen.

6. The information processing apparatus according to claim 1, further comprising a unit configured to prompt a user to set execution of ranging by the second wireless communication without having the object selected by the user.

7. The information processing apparatus according to claim 1, further comprising a unit configured to prompt a user to set whether or not to periodically perform ranging by the second wireless communication, between the information processing apparatus and the apparatus associated with the object, after performing ranging between the information processing apparatus and the apparatus associated with the object by the second wireless communication according to selection of the object performed by the user.

8. The information processing apparatus according to claim 1, wherein the first wireless communication is communication based on BLE (Bluetooth Low Energy), and
wherein the second wireless communication is communication based on UWB (Ultra Wide Band) of an IEEE 802.15.4z standard.

9. The information processing apparatus according to claim 1, wherein the information processing apparatus is a mobile terminal that performs the first wireless communication and the second wireless communication.

10. A method of controlling an information processing apparatus that executes predetermined processing in cooperation with a cooperation target apparatus, comprising:
receiving an advertising packet transmitted by first wireless communication; and
performing control to display a list screen for prompting a user to select the cooperation target apparatus on a display unit of the information processing apparatus based on the advertising packet,
wherein in a case where a transmission source of the advertising packet is an apparatus supporting second wireless communication which makes it possible to acquire distance information with higher accuracy than the first wireless communication, the control includes displaying, on the display unit of the information processing apparatus, the list screen including an object for instructing ranging between the information processing apparatus and the transmission source by the second wireless communication.

11. A non-transitory computer-readable storage medium storing a program for causing a computer to execute a method of controlling an information processing apparatus that executes predetermined processing in cooperation with a cooperation target apparatus,
wherein the method comprises:
receiving an advertising packet transmitted by first wireless communication; and
performing control to display a list screen for prompting a user to select the cooperation target apparatus on a display unit of the information processing apparatus based on the advertising packet,
wherein in a case where a transmission source of the advertising packet is an apparatus supporting second wireless communication which makes it possible to acquire distance information with higher accuracy than the first wireless communication, the control includes displaying, on the display unit of the information processing apparatus, the list screen including an object for instructing ranging between the information processing apparatus and the transmission source by the second wireless communication.
